(19) United States
(12) Patent Application Publication
(10) Pub. No.: US 2024/0322254 A1
(43) Pub. Date: Sep. 26, 2024

(54) LITHIUM-ION BATTERY WITH LOCALIZED HIGH CONCENTRATION ELECTROLYTE

(71) Applicants: Sila Nanotechnologies, Inc., Alameda, CA (US); Battelle Memorial Institute, Richland, WA (US)

(72) Inventors: Naoki NITTA, Alameda, CA (US); Gleb Nikolayevich YUSHIN, Atlanta, GA (US); Xia CAO, Richland, WA (US); Ji-Guang ZHANG, Richland, WA (US)

(21) Appl. No.: 18/608,540

(22) Filed: Mar. 18, 2024

Related U.S. Application Data
(60) Provisional application No. 63/491,222, filed on Mar. 20, 2023.

(51) Int. Cl. H01M 10/0569; H01M 4/02; H01M 4/36; H01M 4/38; H01M 4/505; H01M 4/525; H01M 4/583; H01M 4/66; H01M 10/0525

(52) U.S. Cl. CPC H01M 10/0569; H01M 4/364; H01M 4/386; H01M 4/505; H01M 4/525; H01M 4/583; H01M 4/661; H01M 10/0525; H01M 2004/021; H01M 2004/027; H01M 2004/028

(57) ABSTRACT

A lithium-ion battery includes an anode current collector, a cathode current collector, an anode disposed on and/or in the anode current collector, a cathode disposed on and/or in the cathode current collector, and an electrolyte ionically coupling the anode and the cathode. The electrolyte includes (1) a lithium salt composition, (2) a co-solvent composition, and (3) a diluent composition. In some embodiments, the lithium salt composition includes lithium bis(fluorosulfonyl) imide (LiFSI), the co-solvent composition includes dimethyl carbonate (DMC) and/or ethyl propionate (EP), and the diluent composition includes 1,1,2,2-tetrafluoroethyl-2,2,3,3-tetrafluropropyl ether (TTE). In some embodiments, the anode includes composite particles including carbon and silicon, wherein the composite particles include pores and at least some of the silicon is nanosized silicon in the pores.

### CROSS-REFERENCE TO RELATED APPLICATIONS

The present application for patent claims the benefit of U.S. Provisional Application No. 63/491,222, entitled “LITHIUM-ION BATTERY WITH LOCALIZED HIGH CONCENTRATION ELECTROLYTE,” filed Mar. 20, 2023, which is assigned to the assignee hereof, and expressly incorporated herein by reference in its entirety.

### GOVERNMENT LICENSE RIGHTS

This invention was made with government support under contract number DE-EE0009186 awarded by the Office of Energy Efficiency and Renewable Energy (EERE) within the United States Department of Energy (DOE) and was also made with government support under Contract DE-AC0576RL01830 awarded by the U.S. Department of Energy. The government has certain rights in the invention.

### BACKGROUND

### Field

Aspects of the present disclosure relate generally to energy storage devices, and more particularly to battery technology and the like.

### Background

Owing in part to their relatively high energy densities, relatively light weight, small size, and potential for long lifetimes, advanced rechargeable batteries are desirable for a wide range of consumer electronics, electric vehicles, grid storage and other important applications.

However, despite the increasing commercial prevalence of batteries, further development of these batteries is needed, particularly for applications in low- or zero-emission, hybrid-electrical or fully electric vehicles, consumer electronics, wearable devices, energy-efficient cargo ships and locomotives, drones, aerospace applications, and power grids. In particular, further improvements are desired for various rechargeable batteries, such as Li and Li-ion batteries, Na and Na-ion batteries, and rechargeable K and K-ion batteries and dual-batteries, to name a few.

A broad range of electrolyte compositions may be utilized in the construction of Li and Li-ion batteries and other metal and metal-ion batteries. However, for improved cell performance (e.g., low and stable resistance, high cycling stability, high-rate capability, good thermal stability, long calendar life, etc.), an optimal choice of electrolyte needs to be developed for specific types and specific sizes of active particles in both the anode and cathode, specific total battery cell capacities as well as specific operational conditions (e.g., temperature, charge rate, discharge rate, voltage range, capacity utilization, etc.). In many cases, the choice of electrolyte components and their ratios is not trivial and can be counterintuitive.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries. Unfortunately, Li and Li-ion battery cells with such anodes and conventional electrolytes often require the use of such large amounts of conventional solid-electrolyte interphase (SEI)-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V. Higher cell voltage, broader operational temperature window, and longer cycle life, however, are advantageous for most applications. Such cells may suffer from excessive capacity degradation (e.g., above about 5%), large volume expansion (e.g., above about 10%) and significant gassing (e.g., above about 10% thickness change) when exposed to high temperatures (e.g., above about 50-90° C.) in a fully charged state (e.g., state-of-charge, SOC of about 90-100%) for a prolonged time (e.g., about 12-168 hours). Passing such elevated temperature charging tests is required for most applications. Performance of such cells may also become particularly poor when the anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs.

In certain types of rechargeable batteries, charge storing anode materials may be produced as high-capacity (nano)composite powders (e.g., at least partially comprised of active material nanomaterials or nanostructures that may be embedded on and/or in a porous structure, such as a C-comprising matrix material in some examples; or, oxide-comprising matrix material in other examples), which exhibit moderately high volume changes (e.g., about 8-180 vol. %) during the first charge-discharge cycle and moderate volume changes (e.g., about 4-50 vol. %) during the subsequent charge-discharge cycles. A subset of such charge-storing anode particles may include anode particles with an average size (e.g., diameter or thickness) in the range of about 0.2 to about 40 microns (micrometers). Such a class of charge-storing particles offers great promises for scalable manufacturing and achieving high cell-level energy density and other performance characteristics. Unfortunately, such particles are relatively new and their use in cells using conventional electrolytes may result in relatively poor cell performance characteristics and limited cycle stability. Performance of such battery cells may become particularly poor when the cells are charged to above about 4.1-4.3 V, more so when the cells are charged to above about 4.3-4.4 V and even more so when the cells are charged to above about 4.5 V. Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (“high-temperature outgassing”) (e.g., about 50-90° C. or higher) in a fully charged state (e.g., state-of-charge, SOC, of about 90-100%) for a prolonged time (e.g., about 12-168 hours). Passing such elevated temperature charging tests is required for most applications. Cell performance may also become particularly poor when the high-capacity (nano)composite anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs. Similarly, cell performance may degrade when the porosity of such an anode (e.g., the volume occupied by the spacing between the (nano)composite active anode particles in the electrode and filled with electrolyte, exclusive of closed pores, if any, within the particles themselves that are inaccessible to electrolyte) becomes moderately small (e.g., about 25-35 vol. % after the first charge-discharge cycle) and more so when the porosity of the anode becomes small (e.g., about 5-25 vol. % after the first charge-discharge cycle) or when the amount of a binder and conductive additives in the electrode becomes moderately small (e.g., about 5-15 wt. %) and more so when the amount of the binder and conductive additives in the electrode becomes small (e.g., about 0.5-5 wt. %). Higher electrode density and lower binder and conductive additive content, however, are advantageous for increasing cell energy density and reducing cost. Lower binder content may also be advantageous for increasing cell rate performance.

Examples of materials that exhibit moderately high-volume changes (e.g., about 8-180 vol. %) during the first charge-discharge cycle and moderate volume changes (e.g., about 4-50 vol. %) during the subsequent charge-discharge cycles include (nano)composites comprising so-called conversion-type (which includes both so-called chemical transformation and so-called “true conversion” subclasses) and so-called alloying-type active electrode materials. In the case of metal-ion batteries (such as Li-ion batteries), examples of such conversion-type active electrode materials include, but are not limited to, metal fluorides (such as lithium fluoride, iron fluoride, copper fluoride, bismuth fluoride, their mixtures and alloys, their mixtures or composites with metal nanoparticles or nanostructures, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type active electrode materials include, but are not limited to, silicon, germanium, antimony, aluminum, magnesium, zinc, gallium, arsenic, phosphorous, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

In certain types of rechargeable batteries, high concentrations (e.g., about 1.3 M or greater) of salt or salts may be used to improve the battery performance. For example, high concentrations may be used to improve the passivation of the anode or cathode by surface passivation layers (SEI or CEI respectively), thereby extending cell lifetime. High concentrations of salt(s) may also be used to reduce the added resistance from the SEI and CEI, thereby reducing the cell resistance, particularly at lower temperatures (e.g., <about 15° C.). High concentrations of salt(s) may also be used to reduce the unwanted gas generation at high temperatures (e.g., >about 40° C.), moderately high or high cell voltages (e.g., >about 4.0V), and at the end of life. High concentrations of salt(s) may also be used to passivate metal current collector foils against corrosion. Unfortunately, high salt concentrations also have many drawbacks. High salt concentration may increase the viscosity of the electrolyte, increasing wetting time during battery cell manufacturing (thereby increasing manufacturing cost) and decreasing conductivity and diffusivity of the electrolyte (thereby decreasing battery rate capability and increasing cell resistance, especially at low temperature). Some salts are more expensive than other battery materials and compounds, so high salt concentrations may drive up the cost of the battery cell. Some salts are more dense than other battery materials and compounds, so high salt concentrations may increase the density of the electrolyte, thereby decreasing the mass-based gravimetric energy density of the battery.

Localized high concentration electrolytes (L-HCEs) may mitigate the negative effects of high salt concentration through the use of a diluent. A diluent is a solvent in which the salt(s) have low-to-negligible solubility. For example, solubility of less than about 0.3 M may be referred to as low-to-negligible solubility. The diluent reduces the viscosity of the electrolyte, while maintaining strong interactions between the salt(s) and the other non-diluent co-solvent(s), in which the salt(s) have high solubility. For example, solubility of greater than about 2 M may be referred to as high solubility. The effect of strong interactions between the salt(s) and/or the other non-diluent co-solvent(s) may be similar to what is observed at high salt concentrations. In some cases, the diluent may also passivate the anode, cathode, and/or metal (e.g., current collector metal foil) surfaces against unwanted side reactions. Diluents may also lower the density of the electrolyte. Unfortunately, even with the use of a diluent, the conductivity of the electrolyte may be too low, thereby lowering rate capability, reducing electrode mass loading (and hence reducing volumetric energy density and gravimetric energy density), decreasing roundtrip energy efficiency, and increasing cell internal resistance and heat generation.

Accordingly, careful design and improvement of the electrolyte, battery electrodes, manufacturing processes, and cell usage specifications is necessary.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

One aspect is directed to a lithium-ion battery, including an anode current collector, a cathode current collector, an anode disposed on and/or in the anode current collector, a cathode disposed on and/or in the cathode current collector, and an electrolyte ionically coupling the anode and the cathode. In some embodiments, the electrolyte includes (1) a lithium salt composition, (2) a co-solvent composition, and (3) a diluent composition. In some embodiments, the lithium salt composition includes lithium bis(fluorosulfonyl) imide (LiFSI), the co-solvent composition includes dimethyl carbonate (DMC) and/or ethyl propionate (EP), and the diluent composition includes 1,1,2,2-tetrafluoroethyl-2,2,3,3-tetrafluropropyl ether (TTE). In some embodiments, the anode includes composite particles including carbon and silicon, wherein the composite particles include pores and at least some of the silicon is nanosized silicon in the pores.

Another aspect is directed to a battery pack or a device that utilizes at least one of such a lithium-ion battery.

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode, the electrolyte comprising (1) a lithium salt composition, (2) a co-solvent composition, and (3) a diluent composition, wherein: the lithium salt composition comprises lithium bis(fluorosulfonyl) imide (LiFSI); the co-solvent composition comprises dimethyl carbonate (DMC) and/or ethyl propionate (EP);

the diluent composition comprises 1,1,2,2-tetrafluoroethyl-2,2,3,3-tetrafluropropyl ether (TTE); and the anode comprises composite particles comprising carbon and silicon, the composite particles comprising pores, and at least some of the silicon being nanosized silicon in the pores.

In some aspects, a mole fraction of the LiFSI in the electrolyte is in a range of about 15 mol. % to about 22 mol. %.

In some aspects, a molar ratio of the co-solvent composition to the TTE is in a range of about 1 to about 5.

In some aspects, a mole fraction of the TTE in the electrolyte is in a range of about 15 mol. % to about 40 mol. %.

In some aspects, a molar ratio of the co-solvent composition to the LiFSI is in a range of about 2 to about 4.

In some aspects, a mole fraction of the co-solvent composition in the electrolyte is in a range of about 35 mol. % to about 65 mol. %.

In some aspects, the co-solvent composition additionally comprises one or more cyclic carbonates.

In some aspects, the one or more cyclic carbonates are selected from vinylene carbonate (VC), fluoroethylene carbonate (FEC), ethylene carbonate (EC), and propylene carbonate (PC).

In some aspects, the co-solvent composition additionally comprises one or more esters of no more than five carbons.

In some aspects, the one or more esters are selected from ethyl acetate, methyl butyrate, methyl propionate, and methyl acetate.

In some aspects, the co-solvent composition additionally comprises ethyl methyl carbonate (EMC) and/or diethyl carbonate (DEC).

In some aspects, the electrolyte exhibits an ionic conductivity of greater than about 3 mS/cm at an operating temperature of the lithium-ion battery.

In some aspects, a mass of the silicon is in a range of about 10 wt. % to about 90 wt. % of the anode.

In some aspects, the cathode comprises lithium nickel cobalt manganese oxide (NCM).

In some aspects, the NCM is characterized by a composition LiNiₓCo_{y}Mn_{z}O₂, x+y+z=1, and x≥about 0.8.

In some aspects, a capacity of the lithium-ion battery is at least about 3.3 mAh/cm² after undergoing about 1000 or more charge-discharge cycles at a rate of at least about 0.5 C.

In some aspects, the anode additionally comprises graphite particles.

In some aspects, the anode additionally comprises carbon nanotubes.

In some aspects, the anode additionally comprises carbon black conductive additive.

In some aspects, the anode additionally comprises artificial graphite flakes as conductive additive.

In some aspects, the anode current collector comprises copper.

In some aspects, the cathode current collector comprises aluminum.

Other objects and advantages associated with the aspects disclosed herein will be apparent to those skilled in the art based on the accompanying drawings and detailed description.

### BRIEF DESCRIPTION OF THE DRA WINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

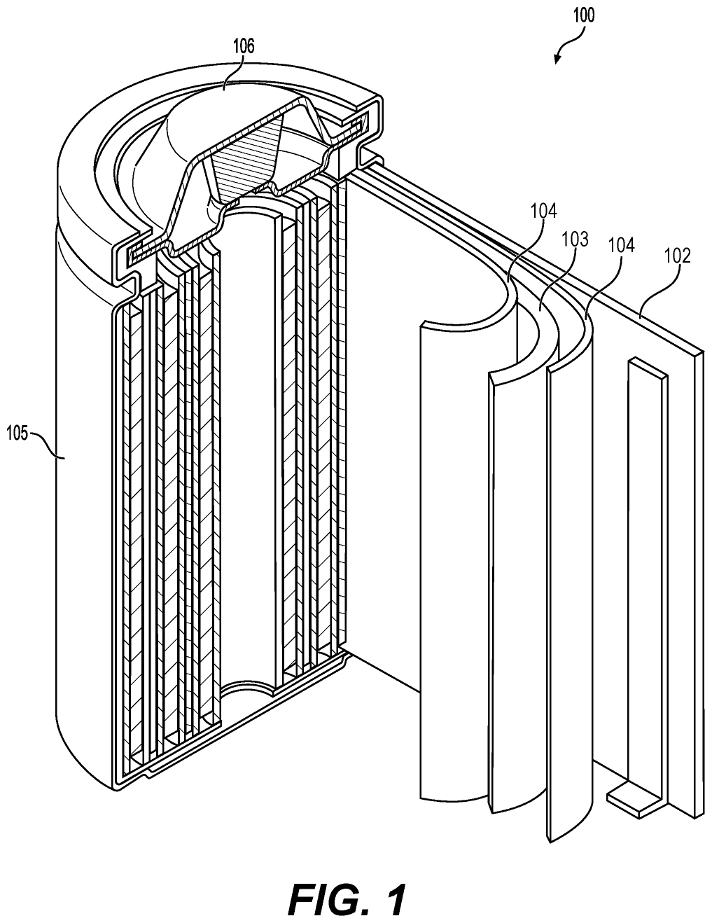

FIG. 1 illustrates an example Li-ion battery in which the electrolytes, components, materials, methods, and other techniques described herein may be implemented.

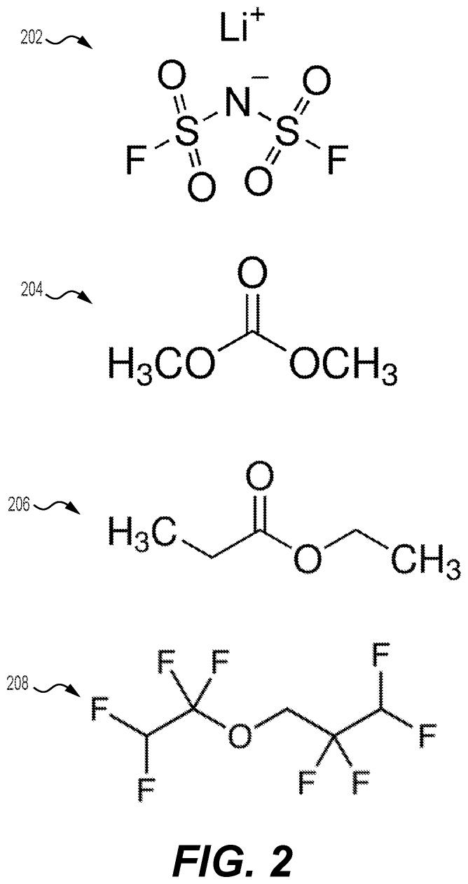

FIG. 2 illustrates examples of compounds for use in a lithium-ion battery electrolyte.

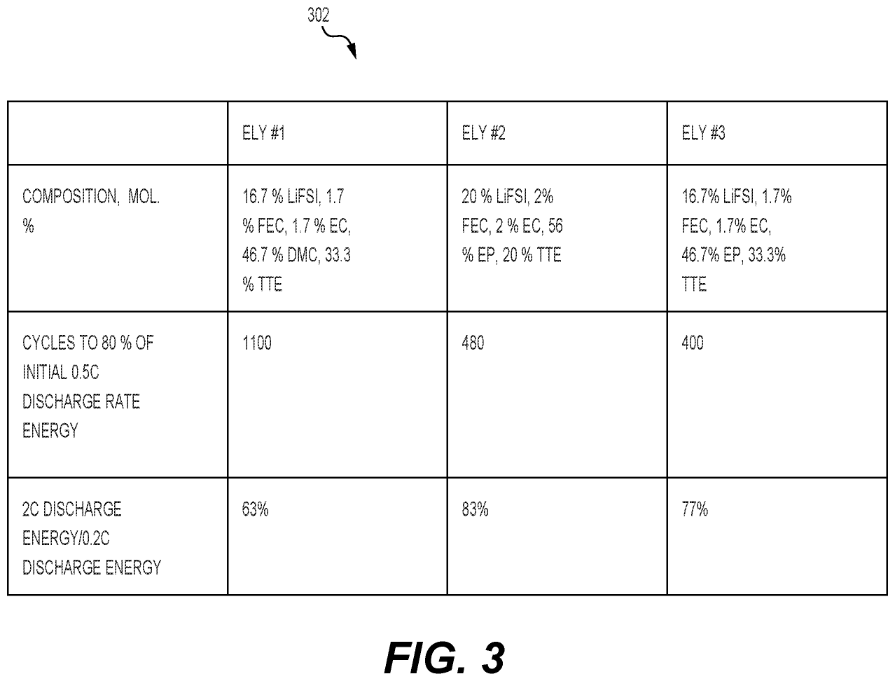

FIG. 3 shows a Table 1 (302) which shows electrolyte compositions and

associated selected battery performance characteristics for electrolytes ELY #1, ELY #2, and ELY #3.

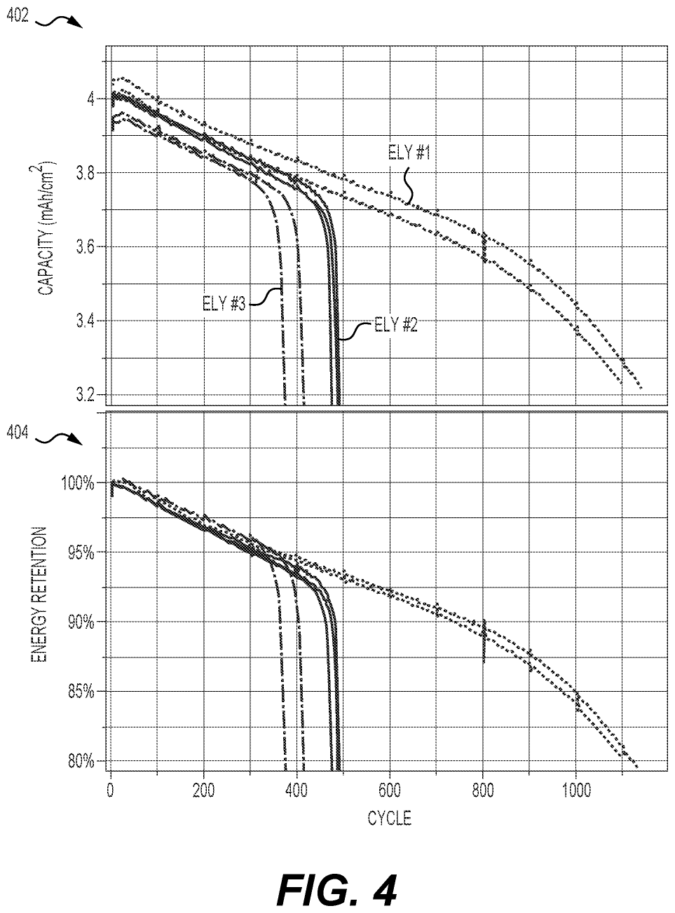

FIG. 4 shows graphical plots of the capacity (402) and energy retention (404) as a function of cycle number for Li-ion battery cells comprising electrolytes ELY #1, ELY #2, and ELY #3.

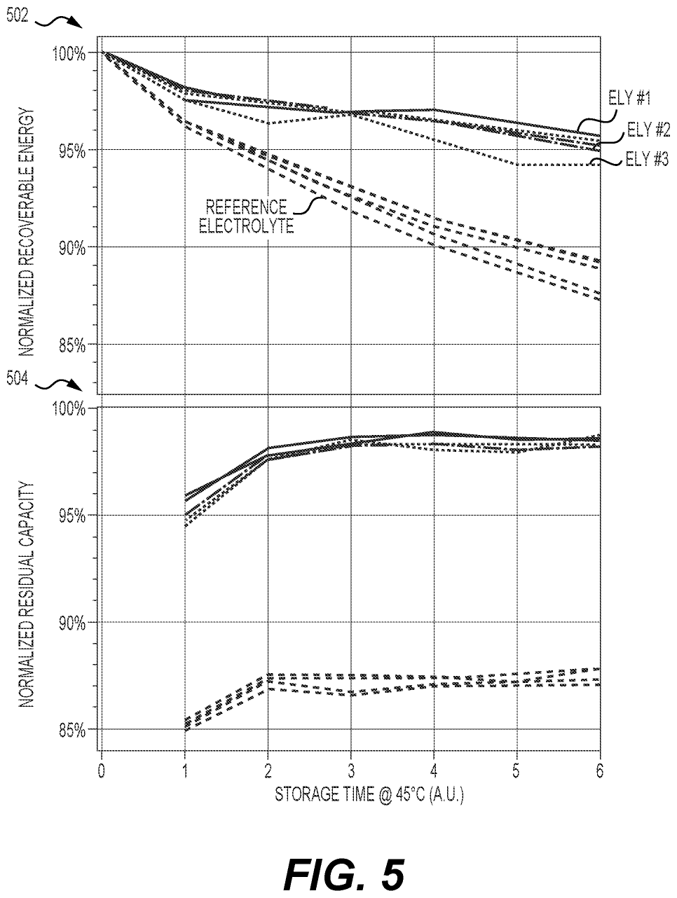

FIG. 5 shows graphical plots of the normalized recoverable energy (502) and normalized residual capacity (504) as a function of storage time at 45° C. for Li-ion battery cells comprising electrolytes ELY #1, ELY #2, ELY #3, and a reference electrolyte. The reference electrolyte does not comprise any diluent and has a salt concentration of 1.2M.

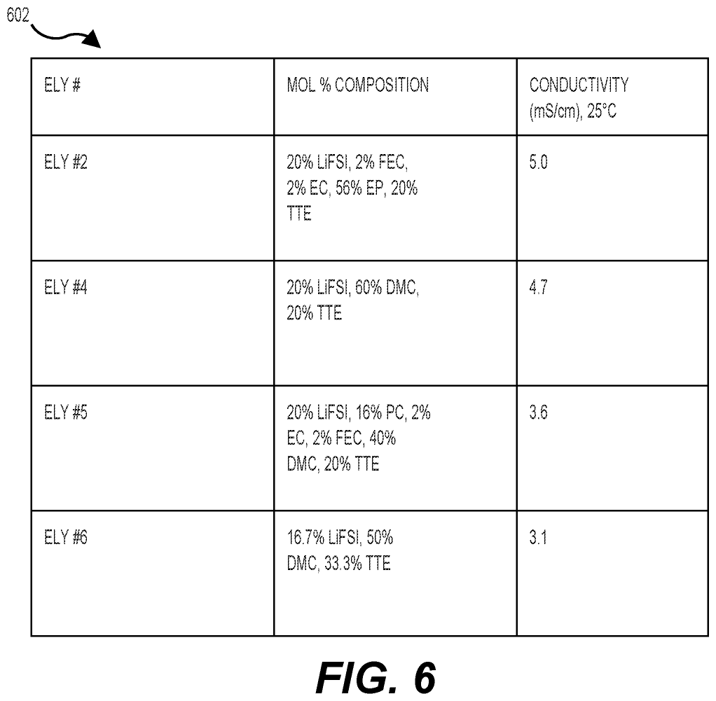

FIG. 6 shows a Table 2 (602) which shows the electrolyte compositions and conductivity characteristics for electrolytes ELY #2, ELY #4, ELY #5, and ELY #6.

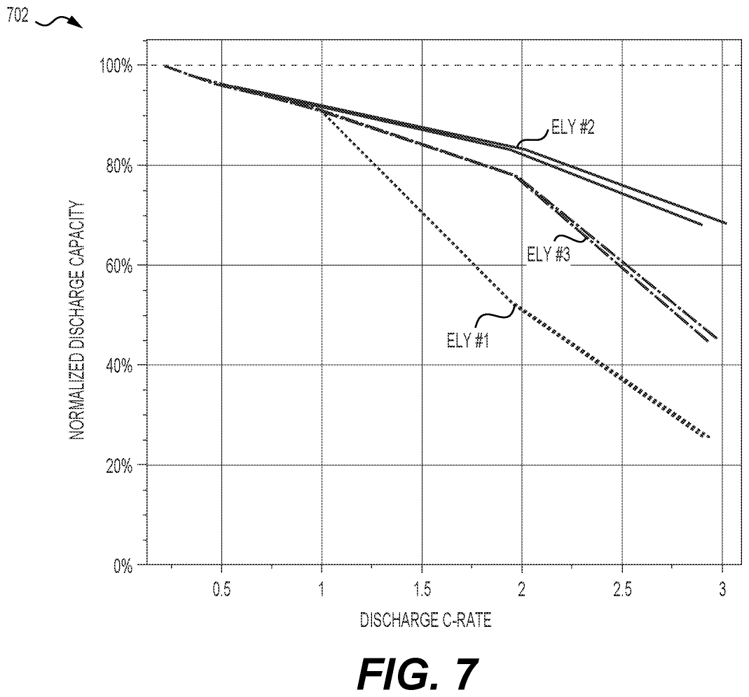

FIG. 7 shows a graphical plot 702 of the reversible discharge capacity as a function of the normalized discharge C-rate for Li-ion battery cells comprising electrolytes ELY #1, ELY #2, and ELY #3.

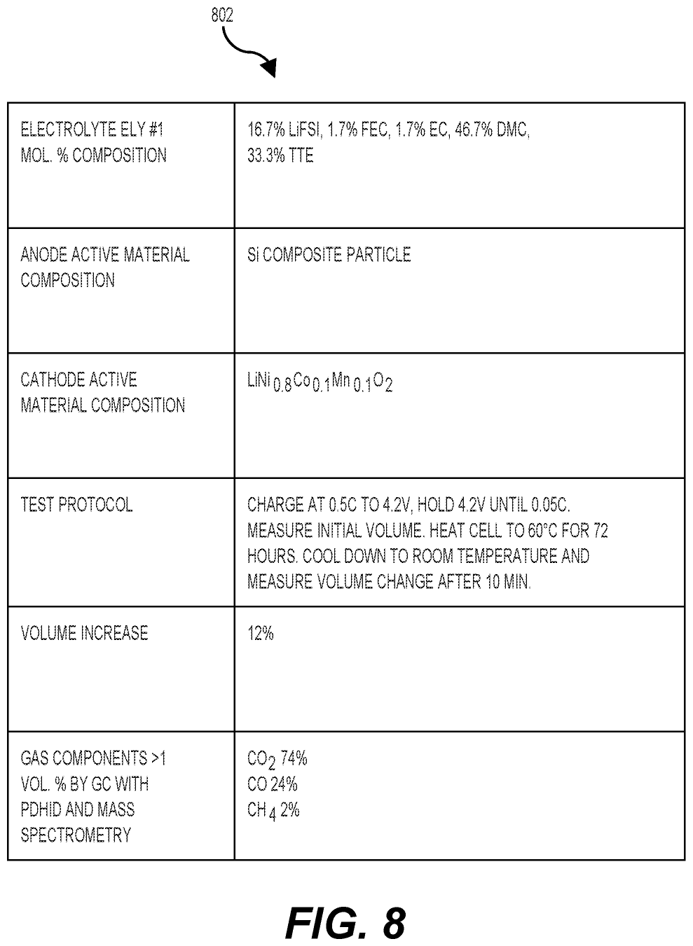

FIG. 8 shows a Table 3 (802) which summarizes the composition of Li-ion battery cells comprising electrolyte ELY #1, the high-temperature outgassing test to which the cells were subjected, and observed outgassing results.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternative embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| | | Measurement | |
|---|---|---|---|
| Material Type | Property Type | Instrumentation | Measurement Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed |
| | | | (discharge current) until a |
| | | | second voltage limit is reached. |
| | | | The ratio of the two charges |
| | | | passed determines the |
| | | | Coulombic Efficiency (CE). In |
| | | | the simplest case, the charge and |
| | | | discharge currents may be |
| | | | constant and often have absolute |
| | | | values that are the same or close |
| | | | to each other. It should be |
| | | | understood though that in some |
| | | | experiments, either charge |
| | | | current or discharge current or |
| | | | both may be changing during |
| | | | such experiments (e.g., be |
| | | | initially constant and when the |
| | | | voltage limit is reached, |
| | | | diminishing to a predetermined |
| | | | value). In addition, the absolute |
| | | | value of the charge and |
| | | | discharge currents may differ. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| Particle | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| | | | Note: A vol. % change may be |
| | | | calculated from two volume |
| | | | measurements of the active |
| | | | material particle. |
| Active | Open Internal | nitrogen | Nitrogen sorption/desorption |
| Material | Pore Volume | sorption/desorption | isotherm (typically at 77 K) is |
| Particle | (e.g., cc/g or | isotherm | collected and analyzed to |
| | cm³/g) | | estimate the total amount of gas |
| | | | adsorbed/desorbed and internal |
| | | | pore volume of the sample with |
| | | | known mass is estimated from |
| | | | such measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger particles) |
| | (e.g., nm) | transmission | and larger pores) in combination |
| | | microscope (STEM), | with image analyses, optical |
| | | laser microscope, | microscopy (for larger particles |
| | | Synchrotron X-ray, | and larger pores), neutron |
| | | X-ray microscope | scattering, X-ray scattering, X- |
| | | | ray microscopy imaging may be |
| | | | employed to measure pore sizes |
| | | | (average pore size or pore size |
| | | | distribution) in different size |
| | | | ranges (in addition to the |
| | | | analysis of the |
| | | | sorption/desorption isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the |
| | | | theoretical density of the |
| | | | individual material components |
| | | | present in Si-comprising |
| | | | particles. In addition, closed |
| | | | internal pore volume may be |
| | | | estimated by comparing the total |
| | | | pore volume estimated from |
| | | | neutron scattering and the |
| | | | nitrogen-accessible pore volume |
| | | | estimated from nitrogen sorption |
| | | | isotherms. |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in the |
| | %, mg, | | particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Fe, F, |
| | | | C, etc.). In case of atoms, the |
| | | | number of atoms may be |
| | | | estimated from the weight of |
| | | | that atom in the particle (e.g., |
| | | | based on gas chromatography) |
| Active | Composition | X-ray Fluorescence | |
| Material | (e.g., mass | (XRF), Inductively | |
| Particle | fraction or wt. | Coupled Plasma | |
| | % of various | Optical Emission | |
| | atomic | Spectroscopy (ICP- | |
| | elements or | OES); Energy | |
| | molecules, | Dispersive | |
| | atomic | Spectroscopy (EDS), | |
| | fraction or at. | Wavelength | |
| | % of various | Dispersive | |
| | elements, etc.) | Spectroscopy | |
| | | (WDS, Electron | |
| | | Energy Loss | |
| | | Spectroscopy | |
| | | (EELS), Nuclear | |
| | | Magnetic Resonance | |
| | | (NMR); Secondary | |
| | | Ion Mass | |
| | | Spectrometry | |
| | | (SIMS); X-Ray | |
| | | Photoelectron | |
| | | Spectroscopy (XPS) | |
| | | Fourier Transform | |
| | | Infrared | |
| | | Spectroscopy (FTIR) | |
| | | and Raman | |
| | | Spectroscopy | |
| | | (Raman) | |
| Active | Specific | Potentiostat | An electrode containing an |
| Material | Capacity | | active anode or cathode material |
| Particle, | | | of interest is charged or |
| Battery Half- | | | discharged (by passing electrical |
| Cell | | | current to the electrode) within |
| | | | certain potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed by |
| | | | multiplying the total mass of the |
| | | | electrode by the active material |
| | | | mass fraction. Both reversible |
| | | | and irreversible capacity during |
| | | | charge or discharge may be |
| | | | calculated in this way. |
| Active | BET SSA | BET instrument | A sample is placed into a sealed |
| Material | (e.g., m²/g) | | chamber at 77 K, where nitrogen |
| Particle | | | is introduced at increasing |
| | | | pressure. The change in pressure |
| | | | of the nitrogen is used to |
| | | | calculate the surface area of |
| | | | the sample. |
| Active | Aspect Ratio | SEM, TEM | The dimensions and shape of the |
| Material | | | particles are typically measured |
| Particle | | | by using SEM or TEM or (for |
| | | | large particles) by using optical |
| | | | microscopy. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions in |
| Population | μm) | scanning electron | one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size distribution |
| | | | (e.g., by SEM image analysis) |
| | | | could also be utilized (and may |
| | | | even lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀ − D₁₀ (sometimes referred to |
| | | | herein as a left width), D₉₀ − D₅₀ |
| | | | (sometimes referred to herein as |
| | | | a right width), and D₉₀ − D₁₀ |
| | | | (sometimes referred to herein as |
| | | | a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by a |
| | | | total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction or wt. | | material particle, binder, etc.) in |
| | %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto the casted electrode may be |
| | | | measured by comparing the |
| | | | weight of the casted electrode |
| | | | before/after the material |
| | | | deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable to | | material in electrode, and |
| | Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable to | balance | capacity (g/mAh) of active |
| | Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacity(ies). Then, measure the |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in the slurry. |
| | Electrode | | |
| Electrode | Areal | Potentiostat and | Areal capacity loading is the |
| | Capacity | balance | weight of the coated active |
| | Loading (e.g., | | material per unit area (g/cm²) |
| | mAh/cm²) | | multiplied by the gravimetric |
| | | | capacity of the active material |
| | | | (not the electrode, but the active |
| | | | material itself with zero binder |
| | | | and zero electrolyte; mAh/g). |
| Electrode | Coulombic | Potentiostat | The change in charge inserted (or |
| | Efficiency | | extracted) to an electrode divided |
| | | | by the charge extracted (or |
| | | | inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half-cell, |
| | | | which is an electrochemical cell |
| | | | consisting of a cathode or anode |
| | | | material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge (de- | | active anode material (or |
| | lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or a |
| | (lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |
| Any Liquid | Surface | Surface Tensiometer | Surface Tension in mN/m may |
| | Tension | (e.g., Bubble | be measured at room |
| | | Pressure | temperature |
| | | Tensiometer) | |
| Any Liquid | Viscosity (cP) | Viscometer (e.g., | Viscosity of a liquid may be |
| | | Brookfield | measured at room temperature |
| | | Viscometer) | |

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline-ion batteries, flow batteries, etc.) as well as electrochemical capacitors and hybrid energy storage devices.

While the description below may describe certain examples with reference to battery electrode compositions, the state of the battery electrode compositions may be in different forms at different stages of manufacture. Generally, the battery electrode composition refers to a plurality of active material particles, such as composite active material particles (e.g., Si—C nanocomposite particles), graphite particles, and so on. Before being mixed into a slurry, the active material particles of the battery electrode composition may be in the form of a dry powder. After being mixed into the slurry, the active material particles of the battery electrode composition may be suspended in a slurry suspension (e.g., along with other electrode components such as a binder, conductive additives, etc.). After the slurry is casted onto a current collector to form an electrode, the slurry is dried (solvent evaporation) and the active material particles of the battery electrode composition are bound together via a binder. After being sealed in a battery cell with other components such as electrolyte, the active material particles may store/release Li-ions during battery operation.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

In some embodiments described below, certain parameters (e.g., temperature, state-of-charge (SOC), etc.) are defined in terms of relative terminology such as low, reduced, high, increased, elevated, and so on. With regard to temperature, unless otherwise stated, this relative terminology may be characterized relative to battery cell storage temperature or battery cell operating temperature, depending on the context of the relevant example. With regard to SOC, unless otherwise stated, a high SOC may be defined as higher than about 70% SOC (e.g., in some designs, about 70-80% SOC; in some designs, about 80-90% SOC; in some designs, about 90-100% SOC).

In one or more embodiments of the present disclosure, a preferred battery cell may include, but not limited to the following: a lithium cobalt oxide (LCO), lithium nickel cobalt manganese oxide (NCM), lithium nickel cobalt aluminum oxide (NCA), lithium nickel cobalt manganese aluminum oxide (NCMA), lithium nickel oxide (LNO) (e.g., doped LNO or LNO with 15-2 at. % of Ni metal substituted by other metals or semimetals, including but not limited to one, two or more of the following: Co, Mn, Al, W, Nb, Ti, Ta, Mg, Sn, Si, Cr, Hf, Mo, Zr, Y, La, among others), lithium manganese oxide (LMO) or lithium nickel manganese oxide (LNMO) as a cathode active material. In some of the preferred examples, a surface of the cathode active material (e.g., LCO, NCM, NCA, etc.) may be coated with one or more layers of ceramic material having a distinctly different composition or microstructure. Illustrative examples of a preferred coating material for a preferred cathode active material may include, but are not limited to metal oxides that comprise one or more of the following metals: Ti, Al, Mg, Sr, Li, Si, Sn, Sb, Nb, W, Cr, Mo, Hf, Ta, B, Y, La, Ce, Zn, and Zr. Illustrative examples of such oxides may include, but are not limited to, titanium oxide (e.g., TiO₂), aluminum oxide (e.g., Al₂O₃), magnesium oxide (e.g., MgO), silicon oxide (e.g., SiO₂), boron oxide (e.g., B₂O₃), lanthanum oxide (La₂O₃), zirconium oxide (e.g., ZrO₂) and other suitable metal or mixed metal oxides and their various mixtures and alloys. In other preferred examples, LCO or NCM may be doped with one or more of Al, Ti, Mg, Zr, Nb, W, La or other metals described above. In some designs, a preferred cathode current collector may comprise aluminum or an aluminum alloy. In some designs, a preferred battery cell may include a polymer separator, a polymer-ceramic composite separator or a ceramic separator. In some designs, such a separator may be stand-alone or may be integrated into an anode or cathode or both. In some designs, a polymer separator may comprise or be made of polyethylene, polypropylene, or a mixture thereof. In some of the preferred examples a surface of a polymer separator may be coated with a layer of ceramic material. Examples of a preferred coating material for polymer separators may include, but are not limited to, titanium oxide (TiO₂), aluminum oxide (Al₂O₃), aluminum hydroxide (Al(OH)₃), aluminum oxyhydroxide (AlO(OH), zirconium oxide (ZrO₂), magnesium oxide (MgO), magnesium hydroxide (Mg(OH)₂) and their various mixtures. In some designs, a preferred battery cell may include a silicon-based and carbon-comprising (which we will refer to as silicon-carbon, irrespective if elements other than Si and C, such as O, N, P, B, S, H, or others are used in its composition nanocomposite; as soon as the total amount of both Si and C exceed about 75 wt. %) (e.g., as used herein, a nanocomposite or (nano)composite is at least partially comprised of active material nanomaterials or nanostructures or nanoparticles, irrespective of whether the nanocomposite or (nano)composite itself is a nanomaterial) or silicon oxide (SiOₓ) or natural or synthetic graphite or soft carbon or hard carbon or their various mixtures and combinations in its anode composition. In some of the preferred examples, the anode active material includes a mixture of silicon-carbon nanocomposite (sometimes abbreviated herein as Si—C nanocomposite) and graphite (e.g., the graphite being separate from the C-part of the Si—C nanocomposite). In some implementations, a Si—C nanocomposite comprises composite particles, which may include Si nanoparticles embedded in pores (e.g., surface pores or internal pores such as closed internal pores or open internal pores) of a porous carbon scaffold particle. Such a porous carbon scaffold particle may comprise graphene material (e.g., curved graphene; with curvature diameter in the range from about 0.5 nm to about 5,000 nm) and/or graphite material. In some designs, a preferred anode current collector may comprise copper or copper alloy. In some designs (e.g., to enhance safety or reduce weight), an anode current collector may additionally comprise a polymer.

In one or more embodiments of the present disclosure, a preferred battery cell may comprise a relatively high areal capacity loading in its electrodes (anodes and cathodes), such as from around 2.0 mAh/cm² to around 12 mAh/cm² (in some implementations, from about 2 to about 3.5 mAh/cm²; in other implementations, from about 3.5 to about 4.5 mAh/cm²; in other implementations, from about 4.5 to about 6.5 mAh/cm²; in other implementations, from about 6.5 to about 8 mAh/cm²; in other implementations, from about 8 to about 12 mAh/cm²).

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Sc, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector. Moreover, as used here, an Li-free state is used to refer to a material that is free of electrochemically active Li, and other types of Li such as in electrochemically inactive compounds may (optionally) be part of such an Li-free material.

During battery (such as a Li-ion battery) operation, conversion materials change (convert) from one crystal structure to another (hence the name “conversion”-type, e.g., an electrochemical reaction). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

In one or more embodiments of the present disclosure, a preferred anode for a battery cell may comprise a mixture or a blend of Si—C nanocomposite (particles) and graphite (or soft carbon or hard carbon) (particles) or their various combinations as the anode active material, i.e., a so-called blended anode. In addition to the anode active material, an anode may comprise inactive material (separate from any inactive material that is made part of active material-comprising composite particles), such as binder(s) (e.g., polymer binder) and other functional additives (e.g., surfactants, electrically conductive additives). In some implementations, the anode active material may be in a range of about 88 wt. % to about 98 wt. % of the anode (not counting the mass of the current collector, in a Li-free state).

While the description below may describe certain examples of suitable intercalation-type graphites to be used in combination with Si—C nanocomposite in a blend, it will be appreciated that various aspects of this disclosure may be applicable to soft-type synthetic graphite, hard-type synthetic graphite, natural graphite, such as pitch coat natural graphite, among others; including but not limited to those which exhibit discharge capacity from about 330 to about 372 mAh/g; including but not limited to those which exhibit low, moderate and high swelling; including but not limited to those which exhibit good and poor compression, including but not limited to those which exhibit Brunauer-Emmett-Teller (BET) surface area of about 1 to about 10 m²/g; including but not limited to those which exhibit first cycle lithiation efficiency of about 90% and more; including but not limited to those which exhibit average particle sizes from about 8 μm to about 18 μm; including but not limited to those which exhibit average densities ranging from about 1.5 g/cm³ to about 2.0 g/cm³; including but not limited to those which exhibit poor, moderate, or good cycle life; including but not limited to those which are at least partially coated and comprise coatings (e.g., with coating thickness from about 2 nm to about 200 nm) to appreciably improve compression, cycle stability and/or springing during cycling.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium nickel manganese oxide (LNMO), lithium cobalt oxide (LCO), lithium cobalt aluminum oxides (LCAO), lithium iron phosphate (LFP), lithium manganese phosphate (LMP), lithium cobalt phosphate (LCP), lithium nickel phosphate (LNP), lithium manganese iron phosphate (LMFP), and other lithium transition metal (TM) oxide or phosphate or sulfate (or mixed) cathodes that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to high-voltage lithium transition metal oxide (or phosphate or sulfate or mixed or other) cathodes where TMs and oxygen (O) are covalently bonded and both TM and O may take part in electrochemical reduction-oxidation (redox) reactions during charge and discharge (including, but not limited to, those oxides or phosphate or sulfate or mixed cathodes that may comprise at least about 0.25 at. % of Mn, Fc, Ni, Co, Nb, Mg, Cr, Mo, Zr, W, Ta, Ti, Hf, Y, La, Sb, Sn, Si, or Ge).

FIG. 1 illustrates an example metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). In some implementations, battery 100 also includes an anode current collector and a cathode current collector. The anode is disposed on and/or in the anode current collector and the cathode is disposed on and/or in the cathode current collector.

Li-ion battery electrolyte salts that are readily commercially available at scale include lithium hexafluorophosphate (LiPF₆), lithium tetrafluoroborate (LiBF₄), SO₂FN⁻ (Li⁺)SO₂F (LIFSI), CF₃SO₂N⁻ (Li⁺)SO₂CF₃ (LiTFSI), lithium triflate (LiOTf), lithium bis(oxalato)borate (LiB(C₂O₄)₂) (LiBOB), lithium difluorophosphate (LFO), and lithium difluoro(oxalato)borate (LiBF₂(C₂O₄)) (LiDFOB). Other salts that may be less common, but may still be applicable include lithium perchlorate (LiClO₄), lithium hexafluoroantimonate (LiSbF₆), lithium hexafluorosilicate (Li₂SiF₆), lithium hexafluoroaluminate (Li₃AlF₆), and various imides (CF₃CF₂SO₂N⁻ (Li⁺)SO₂CF₃, CF₃CF₂SO₂N⁻ (Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others).

Electrodes utilized in Li-ion batteries are typically produced by (i) formation of a slurry comprising active materials, conductive additives, binder solutions and, in some cases, surfactant or other functional additives; (ii) casting the slurry onto a metal current collector foil (e.g., Cu foil for most anodes and Al foil for most cathodes); and (iii) drying the casted electrodes to completely evaporate the solvent.

Conventional anode active materials utilized in Li-ion batteries are of an intercalation-type only (in contrast to a blended anode that may include active material of an intercalation type as well as active material of a conversion-type or alloying-type), whereby metal ions are intercalated into and occupy interstitial positions of such materials during the charge or discharge of a battery. Such (non-blended) anodes experience small or very small volume changes when used in electrodes. Polyvinylidene fluoride, also known as polyvinylidene difluoride (PVDF), and carboxymethyl cellulose (CMC) are the two most common binders used in these electrodes. Carbon black is the most common conductive additive used in these (non-blended) electrodes, followed by flakes of artificial graphite. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode materials for use in Li-ion batteries offer higher gravimetric and volumetric capacities compared to (non-blended) intercalation-type anodes. For example, Earth-abundant silicon (Si) offers approximately 10 times higher gravimetric capacity and approximately 3 times higher volumetric capacity compared to a (non-blended) intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano)composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorous (P), boron (B) or other elements or be allowed with metals. In addition to Si-based composites, silicon oxides (SiOₓ) or oxynitrides (SiOₓN_{y}) or nitrides (SiN_{y}) or other Si element-comprising particles (including those that are partially reduced by Li or Mg) may reduce volume changes and improve cycle stability, although commonly at the expense of higher first cycle losses or faster degradation or both. In some designs, Si-comprising anode particles may exhibit high gravimetric capacities in the range from about 800 mAh/g to about 3000 mAh/g (per mass of Si-comprising anode particles in a Li-free state). Such high specific capacity is advantageous for attaining lighter batteries. However, Li-ion battery cells with anodes comprising high-capacity anode particles may exhibit undesirably fast degradation in conventional electrolytes, particularly at elevated temperatures (e.g., at or above battery operating temperature, e.g., above about 50-80° C.) or when charged to high voltages (e.g., above about 4-4.3 V). In some designs, a subset of anodes with Si-comprising anode particles may include anodes with an electrode layer exhibiting capacity in the range from about 400 mAh/g to about 2800 mAh/g (per mass of the electrode layer, not counting the mass of the current collector, in a Li-free state). Such a class of charge-storing anodes may offer great potential for increasing gravimetric and volumetric energy of rechargeable batteries. However, Li-ion battery cells with anodes comprising high-capacity anode particles may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V). In addition to Si-comprising anodes, other examples of such high-capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorous, silver, cadmium, indium, tin, lead, bismuth, their alloys, and others. In addition to anodes comprising active materials in a metallic form, other interesting types of high-capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) anode active materials may exhibit undesirably fast degradation in conventional electrolytes, particularly at elevated temperatures (e.g., at or above battery operating temperatures, e.g., above about 50-80° C.) or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) anode active materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with alloying-type (or, more broadly, conversion-type) anode active materials may become particularly undesirably fast for cells comprising medium (e.g., about 3-4 g/Ah) or small (e.g., about 2-3 g/Ah) amount of electrolyte when normalized by total cell capacity. However, in some designs, using a medium or a small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions.

High-capacity (nano)composite anode powders (including, but not limited to those that comprise Si), which exhibit moderately high volume changes (e.g., about 8-about 180 vol. %) during the first charge-discharge cycle, moderate volume changes (e.g., about 4-about 50 vol. %) during the subsequent charge-discharge cycles and an average size in the range from about 0.2 to about 40 microns (for some applications, more preferably from about 0.4 to about 20 microns) may be particularly attractive for battery applications in terms of manufacturability and performance characteristics. In particular, a subclass of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (e.g., above about 12 mAh/cm²) are also particularly attractive for use in cells. In some designs, a near-spherical or a spheroidal or an ellipsoid (inc. oblate spheroid) shape of these composite particles may additionally be very attractive for increasing rate performance and volumetric capacity (density) of the electrodes. Note that such high-capacity (nano)composite anode “powders” may be in the form of a “dry” powder (e.g., before being mixed into or suspended in a slurry), in the slurry itself (e.g., in a suspended state), or in a casted electrode (e.g., casted into an electrode, bound together with a suitable binder and/or conductive additives and/or functional additives, and dried).

In spite of some improvements that may be achieved with the formation and utilization of such alloying-type (or conversion-type) active material(s)-comprising (e.g., nanocomposite) anode materials as well as electrode formulations, however, substantial additional improvements in cell performance characteristics may be achieved with improved composition and preparation of electrolytes (e.g., liquid electrolytes), beyond what is known or shown by the conventional state-of-the-art. Unfortunately, high-capacity (nano)composite anode and cathode powders, which exhibit moderately high volume changes (e.g., about 8-about 180 vol. %) during the first charge-discharge cycle, moderate volume changes (e.g., about 4-about 50 vol. %) during the subsequent charge-discharge cycles, an average size in the range from about 0.2 to about 40 microns and relatively low density (e.g., about 0.5-3.8 g/cc), are relatively new and their performance characteristics and limited cycle stability are typically relatively poor, particularly if electrode areal capacity loading is moderate (e.g., from about 2 to about 4 mAh/cm²) and even more so if electrode areal capacity loading is high (e.g., from about 4 to about 12 mAh/cm²) or ultra-high (e.g., above 12 mAh/cm²). Higher capacity loading, however, is advantageous in some designs for increasing cell energy density and reducing cell manufacturing costs. Similarly, the cell performance may suffer when such an electrode (e.g., anode) porosity (e.g., volume occupied by the spacing between the (nano)composite active anode particles in the electrode and filled with electrolyte, exclusive of closed pores, if any, within the particles themselves that are inaccessible to electrolyte) becomes moderately small (e.g., about 25-about 35 vol. %) and more so when the electrode (e.g., anode) porosity becomes small (e.g., about 5-about 25 vol. %) or when the amount of the binder and conductive additives in the electrode (e.g., anode) becomes moderately small (e.g., about 6-about 15 wt. %, in total) and more so when the amount of the binder and conductive additives in the electrode (e.g., anode) becomes small (e.g., about 0.5-about 5 wt. %, in total).

Higher electrode density and lower binder content, however, are advantageous for increasing cell energy density and reducing cost in certain applications. In some designs, lower binder content may also be advantageous for increasing cell rate performance. In some designs, larger volume changes may lead to inferior performance in some designs, which may be related to damages in the solid electrolyte interphase (SEI) layer formed on the anode, to the non-uniform lithiation and delithiation of the electrode particles within the electrodes, and/or other factors. Unfortunately, Li and Li-ion battery cells with such anodes and conventional electrolytes often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). In some designs, performance of such battery cells may become particularly poor when the cells are charged to above about 4.3-4.4 V and even more so when the cells are charged to above about 4.5 V.

Higher cell voltage, broader operational temperature window and longer cycle life, however, is advantageous for most applications. In some designs, such cells (e.g., cells with high amounts of conventional SEI-building additives) may suffer from excessive capacity degradation (e.g., above about 5%), large volume expansion (e.g., above about 10%) and significant gassing when exposed to high temperatures (e.g., above about 50-90° C.) in a fully charged state (e.g., state-of-charge, SOC, of about 90-100%) for a prolonged time (e.g., about 12-168 hours). Passing such elevated temperature charging tests is often required for most applications. In some designs, degradation of Li-ion cells comprising high-capacity (nano)composite anode powders, which exhibit moderately high volume changes during the first charge-discharge cycle, moderate volume changes during the subsequent charge-discharge cycles and an average size in the range from about 0.2 to about 40 microns may degrade particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, Li-ion cells with such volume changing anode particles may degrade particularly undesirably fast for cells comprising medium (e.g., about 2-4 mL/Ah) or small (e.g., about 1-2 mL/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

One or more embodiments of the present disclosure overcome some of the above-discussed challenges of various types of metal-ion (e.g., Li-ion) cells comprising high-capacity nanocomposite anode materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 4-about 50 vol. %) during the subsequent charge-discharge cycles), may exhibit an average particle size in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle, excluding the current collector) and relatively low binder content (e.g., about 0.5-about 14 wt. %, excluding the current collector), may comprise moderate or small amount of electrolyte per cell capacity (e.g., less than about 2 mL/Ah), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., SOC of about 70-100%) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

Conventional cathode active materials utilized in Li-ion batteries are of an intercalation-type only (in contrast to a blended cathode that may include active material of an intercalation type as well as active material of a conversion-type or alloying-type) and commonly crystalline and polycrystalline. Such (non-blended) cathodes typically exhibit a highest charging potential of less than about 4.3 V vs. Li/Lit, reversible gravimetric capacity of less than about 190 mAh/g (based on the mass of active material) and reversible volumetric capacity of less than about 800 mAh/cm³ (based on the volume of the electrode and not counting the volume occupied by the current collector foil). For given anodes, higher energy density in Li-ion batteries may be achieved either by using high-voltage cathodes (cathodes with a highest charging potential from about 4.3 V vs. Li/Li⁺ to about 5.1 V vs. Li/Li⁺) or by using cathodes comprising so-called conversion-type cathode active materials (including, but not limited to those that comprise F or S in their composition). Some high-voltage intercalation-type cathodes may comprise nickel (Ni). Some high-voltage intercalation-type cathodes may comprise manganese (Mn). Some high-voltage intercalation-type cathodes may comprise iron (Fe). Some high-voltage intercalation-type cathodes may comprise cobalt (Co). Some high-voltage intercalation-type cathodes may comprise aluminum (Al). Some high-voltage intercalation-type cathodes may comprise, as a dopant, silicon (Si), tin (Sn), antimony (Sb), or germanium (Ge) or their various combinations. In some designs, high-voltage intercalation-type cathode particles may comprise fluorine (F) as a dopant in their structure or the surface layer. Some high-voltage intercalation-type cathodes may comprise phosphorous (P) as a dopant. Some high-voltage intercalation-type cathodes may comprise sulfur (S) as a dopant. Some high-voltage intercalation-type cathodes may comprise selenium (Se) as a dopant. Some high-voltage intercalation-type cathodes may comprise tellurium (Te) as a dopant. Some high-voltage intercalation-type cathodes may comprise titanium (Ti) as a dopant. Some high-voltage intercalation-type cathodes may comprise niobium (Nb) as a dopant. Some high-voltage intercalation-type cathodes may comprise tungsten (W) as a dopant. Some high-voltage intercalation-type cathodes may comprise molybdenum (Mo) as a dopant. Some high-voltage intercalation-type cathodes may comprise magnesium (Mg). Some high-voltage intercalation-type cathodes may comprise zirconium (Zr). Combination of such (or similar) types of higher energy density cathodes with high-capacity (e.g., Si based) anodes may result in high cell-level energy density. Unfortunately, the cycle stability and other performance characteristics of such cells may not be sufficient for some applications, at least when used in combination with conventional electrolytes.

One or more embodiments of the present disclosure are thereby directed to electrolyte compositions that work well for a combination of high voltage intercalation cathodes (cathodes with the highest charging potential in the range from about 4.0-4.2 V to about 4.5 V vs. Li/Li⁺ and, in some cases, from about 4.5 V vs. Li/Li⁺ to about 5.1 V vs. Li/Li⁺) with a subclass of high-capacity moderate volume changing anodes (e.g., anodes comprising (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles), which exhibit an average particle size (e.g., average diameter) in the range from about 0.2 to about 40 microns and specific surface area in the range from about 0.5 to about 50 m²/g (when normalized by the mass of the composite electrode particles) and, in the case of Si-comprising anodes, specific capacities in the range from about 400 to about 2800 mAh/g (when normalized by the total mass of all the anode particles, conductive or other additives and binders, but does not include the weight of the current collectors) or in the range from about 650-800 to about 3000 mAh/g (when normalized by the mass of the Si-comprising anode particles only). In at least one embodiment, a particular electrolyte composition may be selected based on the value of the highest cathode charge potential or the highest operating temperature or the longest cycle or calendar life requirement.

One or more embodiments of the present disclosure are also directed to electrolyte compositions that work well for a combination of (i) a subclass of moderate capacity (e.g., about 150-260 mAh/g per mass of active materials, in some designs), high-voltage intercalation-type cathodes (which may be layered cathodes in some designs; which may comprise Ni or Co or Mn or a combination of some of such metals in some designs, such as, for example, LCO (lithium cobalt oxides), NCA (lithium nickel cobalt aluminum oxides), NCMA (lithium nickel cobalt manganese aluminum oxides), LNO (lithium nickel oxides), LMO (lithium manganese oxides), NCM (lithium nickel cobalt manganese oxides, also known as NMC), LCAO (lithium cobalt aluminum oxides), LCP (lithium cobalt phosphates), LMP (lithium manganese phosphate), LNP (lithium nickel phosphate), LFP (lithium iron phosphate), LMFP (lithium manganese iron phosphate) or others), which are charged to above about 4.1 V vs. Li/Li⁺ during full cell battery cycling (in some designs, above about 4.2 V vs. Li/Li⁺; in other designs, above 4.3 V vs. Li/Li⁺; in yet other designs, above about 4.4 V vs. Li/Lit; in yet other designs, above about 4.5 V vs. Li/Li⁺; in yet other designs, above about 4.6 V vs. Li/Li⁺) with (ii) a subclass of high-capacity moderate volume changing anodes: anodes comprising about 5-about 100 wt. % of (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only).

The inventors have found that, in some designs, cells comprising anode electrodes based on high-capacity nanocomposite anode particles or powders (comprising conversion- or alloying-type anode active materials) that experience certain volume changes during cycling (moderately high volume changes (e.g., an increase by about 8-about 180 vol. % or a reduction by about 8-about 70 vol. %) during the first charge-discharge cycle and moderate volume changes (e.g., about 4-about 50 vol. %) during the subsequent charge-discharge cycles) and an average size in the range from about 0.2 to about 40 microns (such as Si-based nanocomposite anode powders, among many others) may benefit from specific compositions of electrolytes that provide significantly improved performance (particularly for high-capacity loadings or small electrolyte fractions or large cells).

For example, (i) continuous volume changes in high-capacity nanocomposite particles during cycling in combination with (ii) electrolyte decomposition on the electrically conductive electrode surface at electrode operating potentials (e.g., mostly electrochemical electrolyte reduction in the case of Si-based based anodes) may lead to a continuous (even if relatively slow) growth of a solid electrolyte interphase (SEI) layer on the surface of the nanocomposite anode particles and the resulting irreversible losses in cell capacity. In some designs, the addition of some known SEI-forming additives may improve SEI stability during cycling but may induce undesirable electrolyte oxidation on the cathode (particularly at higher voltages or elevated temperature), resulting in gassing, cell swelling and reduced cycle and calendar life. In some designs, the addition of some known cathode solid electrolyte interphase (CEI)-forming additives may induce protective film formation on the cathode, reducing further electrolyte oxidation and gassing, but often at the expense of reduced SEI stability on the anode or other undesirable effects. In some designs, Localized High Concentration Electrolytes (L-HCEs) may improve the stability of the SEI without inducing undesirable electrolyte oxidation on the cathode. In some designs, L-HCEs may reduce the rate of undesirable electrolyte oxidation on the cathode, and in some designs may increase desirable electrolyte oxidation reactions on the cathode which reduce or prevent other gas generating electrolyte reactions from happening, for example, by forming a CEI. In some designs, L-HCEs may improve calendar life of the described Li-ion battery cells.

The inventors have found that, in some designs, cells comprising blended anode electrodes based on Si-nanocomposite and graphite particles or powders, may benefit from electrolytes which exhibit moderate to minimal fluoroethylene carbonate (FEC) mole concentration, moderate to none ethylene carbonate (EC), and low-to-none vinylene carbonate (VC) concentration, wherein low to minimal is about 5 mol % to 0.5 mol %, low to none is about 5 mol % to 0 mol %, and moderate to none is about 20 mol % to 0 mol %. FEC, VC, and EC are examples of cyclic carbonates. For example, some electrolytes with lower concentrations of FEC and VC may exhibit longer cycle life, reduced high temperature outgassing on the cathode, decreased voltage hysteresis, reduced SEI resistance, higher energy throughput (i.e. total energy stored by the battery cell during its lifetime), and decreased battery self-heating during operation.

In some designs, swelling of binder(s) in electrolyte(s) depends not just on the binder composition(s), but may also depend on the electrolyte composition(s). Furthermore, in some designs, such swelling (and the resulting performance reduction) often correlates with the reduction in clastic modulus upon exposure of binders to electrolytes. In this sense, the smaller the reduction in modulus in certain electrolytes, the more stable the binder-linked (nano)composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

One aspect of the present disclosure is directed to an electrolyte for a lithium-ion battery. In some designs, the electrolyte comprises lithium salt composition, a co-solvent composition, and a diluent composition. In some implementations, the lithium salt composition may preferably comprise lithium bis(fluorosulfonyl)imide (LiFSI) (shown as 202 in FIG. 2) as a primary lithium salt. In some implementations, a mole fraction of the primary lithium salt (e.g., LiFSI) in the electrolyte may preferably be in a range of approximately 15 mol. % to approximately 22 mol. %. In some implementations, a concentration of the primary lithium salt in the electrolyte may preferably be in a range of approximately 8 mol. % to approximately 15 mol %, in which case the electrolyte comprises one or more additional salts with a total salt mole fraction of approximately 15 mol. % to approximately 22 mol. %. In some designs, it may be advantageous to use a higher molarity (or a higher mole fraction) of certain salt(s) (such as LiFSI) to stabilize the anode SEI and increase the cycle life of the cell. In some designs, it may be advantageous to use a higher molarity (or a higher mole fraction) of salt(s) to improve the operation of electrolyte at low temperatures, such as from about −30° C. to about +10° C. In some designs, it may be advantageous to use a higher molarity (or a higher mole fraction) of salt(s) to decrease HT outgassing. In some designs, a higher molarity (or a higher mole fraction) of certain salts may lead to poor charge and discharge rate capability. In some designs, if the molarity (or mole fraction) of the salt is too high, the operation of the electrolyte at lower temperatures may be degraded. The optimal salt molarity (or mole fraction) may depend on the particular cell design and electrolyte composition.

High-temperature outgassing in a battery cell is an undesirable phenomenon that is observed to result from a heat treatment (also referred to as high-temperature storage treatment) of the battery cell after it has been charged to a high state-of-charge (SOC). The temperature of the heat treatment may vary depending on the specific heat treatment implementation, e.g., about 80° C., about 72° C., about 60° C., and other temperatures in a range of about 50° C. to about 90° C. The duration of the heat treatment may also vary depending on the specific heat treatment implementation, e.g., about 10 days, about 7 days, about 3 days, about 2.5 days, about 2 days, and other durations. In some Li-ion battery tests conducted by the inventors, the heat treatment was conducted at a temperature of 60° C. for a duration of 72 hours (3 days).

A measurement of the volume of the gases formed in the cell constitutes a metric for the high-temperature outgassing test. In one example, the volume of the gases in the cell at atmospheric pressure (“gas volume”), measured 10 minutes after the cell has been cooled to 25° C. after the high-temperature storage treatment under a high state-of-charge (SOC), is compared to the initial volume of the cell before the high-temperature storage treatment under a high state-of-charge (SOC). In some implementations, the gas volume preferably does not exceed about 20 vol. % of the initial volume of the cell. In some implementations, the gas volume preferably does not exceed about 12 vol. % of the initial volume of the cell. In some implementations, the gas volume preferably does not exceed about 3 vol. % of the initial volume of the cell. In some implementations, the gas volume preferably does not exceed about 1 vol. % of the initial volume of the cell.

In one or more embodiments of the present disclosure, an electrolyte for a lithium-ion battery may include (1) a lithium salt composition, (2) a co-solvent composition, and (3) a diluent composition. In some implementations, the lithium salt composition includes lithium bis(fluorosulfonyl) imide (LiFSI) as a primary lithium salt (e.g., as used herein, the “primary” lithium salt corresponds to the lithium salt with the highest wt. % in the lithium salt composition), and exhibits one or more of the following characteristics: higher ionic conductivity, stronger coordination between salt and solvent molecules, lower cell resistance, higher rate capability, longer cycle life, and longer calendar life, compared to one or more non-primary lithium salts in the lithium salt composition. In some cases, LiFSI may constitute at least about 80 wt. % (e.g., about 80-about 90 wt. %, about 90-about 98 wt. %, or about 98-about 100 wt. %) of the lithium salt composition. In some implementations, other salts (LiPF₆, LiTFSI, LiOTf, etc.) may be employed as a primary salt in the lithium salt composition. In some implementations in which LiFSI is employed as a primary lithium salt in the lithium salt composition, the mole fraction (concentration) of the LiFSI in the electrolyte may be in a range of about 15 mol. % to about 22 mol. % (e.g., in a range of about 15 mol. % to about 18 mol. %, in a range of about 18 mol. % to about 22 mol. %, etc.). In some implementations in which LiFSI is employed as a primary lithium salt in the lithium salt composition, the mole fraction (concentration) of the LiFSI in the electrolyte may be in a range of about 10 mol. % to about 15 mol. %. In some implementations in which LiFSI is employed as a primary lithium salt in the lithium salt composition, the mole fraction (concentration) of the LiFSI in the electrolyte may be in a range of about 22 mol. % to 25 mol. %. In some implementations, the lithium salt composition may include additional salts in addition to the primary salt (e.g., LiFSI).

In some designs, the co-solvent composition includes one or more compounds that help to solvate the lithium salt composition. In some implementations, the mole fraction of the co-solvents may be increased to increase the conductivity of the electrolyte, and thereby increase the rate capability of the battery cell. In some implementations, the co-solvent composition includes a linear carbonate (such as, for example, dimethyl carbonate (DMC) (shown as 204 in FIG. 2) or diethyl carbonate (DEC) or ethyl methyl carbonate (EMC), etc.). In some implementations, the linear carbonate (e.g., DMC) may constitute at least about 60 wt. % (e.g., about 60-about 70 wt. %, about 70-about 80 wt. %, about 80-about 90 wt. %, about 90-about 95 wt. %, about 95-about 99 wt. %, or about 99-about 100 wt. %) of the co-solvent composition. In some implementations in which a linear carbonate (such as DMC) is employed in the co-solvent composition, the mole fraction (concentration) of the linear carbonate (e.g., DMC in the electrolyte may be in a range of about 35 mol. % to about 65 mol. % (e.g., in a range of about 35 mol. % to about 45 mol. %, in a range of about 45 mol. % to about 55 mol. %, or in a range of about 55 mol. % to about 65 mol. %).

In some implementations, the co-solvent composition includes a linear ester (or a mixture of linear esters) comprising three to six carbon atoms per molecule, such as an ester ethyl propionate (EP) comprising 5 carbon atoms, shown as 206 in FIG. 2. In some implementations, linear ester (e.g., EP) may constitute at least about 60 wt. % (e.g., about 60-about 70 wt. %, about 70-about 80 wt. %, about 80-about 90 wt. %, about 90-about 95 wt. %, about 95-about 99 wt. %, or about 99-about 100 wt. %) of the co-solvent composition. In some implementations in which EP is employed in the co-solvent composition, the mole fraction (concentration) of the EP in the electrolyte may be in a range of about 40 mol. % to about 60 mol. % (e.g., in a range of about 40 mol. % to about 50 mol. %, or in a range of about 50 mol. % to about 60 mol. %). In some implementations in which EP is employed in the co-solvent composition, the mole fraction (concentration) of the EP in the electrolyte may be in a range of about 35 mol. % to about 40 mol. %. In some implementations in which EP is employed in the co-solvent composition, the mole fraction (concentration) of the EP in the electrolyte may be in a range of about 60 mol. % to about 65 mol. %. In some implementations, the co-solvent composition may include a combination (a mixture) of DMC and EP.

In some implementations, the co-solvent composition may additionally include (e.g., in addition to DMC and/or EP), one or more linear carbonate compounds such as ethyl methyl carbonate (EMC) and/or diethyl carbonate (DEC). In some implementations, the co-solvent composition may additionally include one or more cyclic carbonates such as vinylene carbonate (VC), vinyl ethylene carbonate (VEC), fluoroethylene carbonate (FEC), ethylene carbonate (EC), and propylene carbonate (PC). In some implementations in which VC or VEC is employed in the co-solvent composition, a mole fraction (concentration) of the VC or VEC in the electrolyte may be in a range of about 0.25 mol. % to about 2 mol. %. In some implementations in which FEC is employed in the co-solvent composition, a mole fraction (concentration) of the FEC in the electrolyte may be in a range of about 0.25 mol. % or 0.5 mol. % to about 5 mol. %. In some implementations in which EC is employed in the co-solvent composition, a mole fraction (concentration) of the EC in the electrolyte may be in a range of about 1 mol. % to about 5 mol. %. In some implementations in which PC is employed in the co-solvent composition, a mole fraction (concentration) of the PC in the electrolyte may be in a range of about 1 mol. % to about 20 mol. %. In some implementations, it may be advantageous for a total mole fraction of the cyclic carbonates to be quite low in order to increase the conductivity of the L-HCE. In some implementations, a total mole fraction of the cyclic carbonates may be in a range of about 0.5 to about 5 mol. %. In such cases, the cyclic carbonates may be considered as being present in the electrolyte at additive-level concentrations. In some implementations, a total mole fraction of the cyclic carbonates may be in a range of about 5 to about 10 mol. %. In some implementations, a total mole fraction of the cyclic carbonates may be in a range of about 10 to about 20 mol. %.

In some implementations, the co-solvent composition of the electrolyte includes FEC. In some implementations, a mole fraction (concentration) of FEC in the electrolyte may preferably be in a range of approximately 4 mol. % to approximately 30 mol. % (in some implementations, from about 4 mol. % to about 10 mol. %; in other implementations, from about 10 mol. % to about 18 mol. %; in yet other implementations, from about 18 mol. % to about 30 mol. %). In some implementations, a concentration of FEC in the electrolyte may be in a range of approximately 0.5 mol. % to approximately 30 mol. %. In some designs, when the concentration of FEC in the electrolyte is too low (e.g., in some implementations, less than about 0.5 to about 5 mol. % or about 0.5 to about 1 mol. %), the cycle life may degrade undesirably fast because of insufficient amount of suitable SEI builders. In some designs, there is more SEI formation when the FEC concentration is greater than approximately 5 mol. %. However, in some designs, increasing FEC concentrations may undesirably be accompanied by increased high-temperature outgassing, as well as lower discharge voltages (due to the overly resistive SEI formation) and/or increased viscosity of the electrolyte (due to the high viscosity of FEC). Lower discharge voltages may result in lower volumetric energy densities (VEDs), and higher viscosities may result in lower ionic conductivities. For these reasons, in some designs, the FEC concentration should preferably be set to below a certain threshold (e.g., mol. % threshold) in some designs. In some implementations, the FEC concentration should preferably not exceed approximately 30 mol. %. In some implementations, the FEC concentration preferably does not exceed approximately 5 mol. %. In some implementations, FEC may provide better cycle life by being used in combination with other SEI builder compounds.

In some implementations, the co-solvent composition includes VC. In some implementations, a mole fraction (concentration) of VC in the electrolyte may preferably be in a range of about 0.5 mol. % to about 2 mol. % (e.g., in a range of about 0.5 to about 1 mol. %, or in a range of about 1 to about 2 mol. %). In some designs, within a preferred concentration range (e.g., mole fraction in a range of about 0.5 mol. % to about 1 mol. %, or mole fraction in a range of about 1 mol. % to about 2 mol. %), the presence of VC in the electrolyte may contribute to a preferable balance of good cycle life, good ionic conductivity, and high discharge voltage.

In some implementations, it may be advantageous to use ethylene carbonate (EC) as an SEI “builder” as a component of the co-solvent composition. In some implementations, EC may be used as an SEI “builder” to build SEI, which helps to improve cycle life. In some implementations, EC may provide better cycle life by being used in combination with other SEI “builder” compounds. In some implementations, EC may be more suitable as a SEI “builder” when graphite particles are blended into the anode. In some implementations, a good balance between cycle life, ionic conductivity, discharge voltage, and low-temperature performance may be achieved when the mole fraction of EC in the electrolyte is about 0.5 mol. % to about 1 mol. %, about 1 mol. % to about 5 mol. %, or about 5 mol. % to 15 mol. %.

In some implementations, the presence of certain surface passivating salts (e.g., LiFSI) and/or diluents (e.g. TTE) in an electrolyte may reduce the need for other SEI builders, enabling electrolytes that comprise FEC, VC, and/or EC at lower mole fractions than to attain high cycle life. For example, if the electrolyte comprises LiFSI at a mole fraction in a range of about 10 mol. % to about 25 mol. % (e.g., in a range of about 10 to about 15 mol. %, in a range of about 15 to about 18 mol. %, in a range of about 18 to about 20 mol. %, in a range of about 20 to about 22 mol. %, in a range of about 22 to about 25 mol. %), lower FEC, VC, and/or EC mole fractions may be sufficient to achieve high cycle life.

In one or more embodiments of the present disclosure, a preferred co-solvent composition for a Li-ion battery electrolyte may include at least one linear carbonate (LC). Examples of suitable linear carbonates may include, but are not limited to: dimethyl carbonate (DMC), ethyl methyl carbonate (EMC), and diethyl carbonate (DEC). In one or more embodiments of the present disclosure, a preferred co-solvent composition for a lithium-ion battery electrolyte may include DMC as a primary co-solvent. The molecular weights of these linear carbonate compounds are about 90.08 g/mol (DMC), about 104.10 g/mol (EMC), and 118.13 g/mol (DEC), respectively. These linear carbonates are notable for their relatively low viscosities (e.g., approximately 0.59 cP for DMC and approximately 0.65 cP for EMC, at about 25° C.). Accordingly, in some designs, the viscosity of an electrolyte may be decreased by adding one or more of these linear carbonates. For example, in some electrolyte formulations, DMC may increase discharge voltage and improve low-temperature performance.

In some implementations, the co-solvent composition may additionally include (e.g., in addition to DMC and/or EP), one or more ester compounds. In some cases, one or more ester compounds of no more than six carbons may be employed in the co-solvent composition. In some cases, one or more ester compounds of no more than five carbons may be employed in the co-solvent composition. In some cases, one or more ester compounds of three to five carbons may be employed in the co-solvent composition. For example, one or more of the following ester compounds may be employed in the co-solvent composition: ethyl propionate (EP) (5 carbons), ethyl acetate (EA) (4 carbons), methyl butyrate (MB) (5 carbons), methyl propionate (MP) (4 carbons), and methyl acetate (MA) (3 carbons). In some implementations, the co-solvent composition does not comprise ethyl propionate (e.g., the co-solvent composition comprises DMC but does not comprise EP). In some implementations in which one or more esters other than EP are employed in the co-solvent composition, a mole fraction (concentration) of the one or more esters other than EP in the electrolyte may be in a range of about 1 mol. % to about 30 mol. %.

In one or more embodiments of the present disclosure, the co-solvent composition of the electrolyte may include at least one ester compound, such as EP, EA, MB, MP, and/or MA. In some embodiments of the present disclosure, a suitable composition of ester compounds may contribute to better ionic conductivity in the electrolyte, better discharge rate capability, better fast charge performance, reduced HT outgassing, reduced end-of-life outgassing, better calendar life, and/or better low-temperature performance.

In some designs, the co-solvent composition may comprise DMC and/or EP and may additionally include one or more other compounds such as other linear carbonates (e.g., EMC, DEC, etc.), other esters (e.g., EA, MB, MP, MA, etc.), and/or cyclic carbonates (e.g., VC, FEC, EC, PC). In some implementations, a mole fraction (concentration) of the co-solvent composition in the electrolyte may be in a range of about 35 mol. % to about 65 mol. % (e.g., in a range of about 35 mol. % to about 45 mol. %, in a range of about 45 mol. % to about 55 mol. %, in a range of about 55 mol. % to about 65 mol. %, in a range of about 35 mol. % to about 50 mol. %, in a range of about 50 mol. % to about 65 mol. %, in a range of about 35 mol. % to about 40 mol. %, in a range of about 40 mol. % to about 50 mol. %, in a range of about 50 mol. % to about 60 mol. %, or in a range of about 60 mol. % to about 65 mol. %). In some implementations in which LiFSI is employed in the lithium salt composition, a molar ratio of the co-solvent composition to the LiFSI may be in a range of about 2 to about 4 (e.g., about 2 to about 3, or about 3 to about 4).

In one or more embodiments of the present disclosure, the electrolyte includes a diluent composition. In some designs, the diluent composition preferably includes compounds in which the electrolyte's salt(s) (e.g., LiFSI) have solubility of less than about 0.3 M. Furthermore, in some designs, the compounds of the diluent composition are preferably sufficiently stable against reduction at the anode and oxidation at the cathode, either by being unreactive or by undergoing passivation reactions. In some implementations, the compounds of the diluent composition preferably do not vaporize from the electrolyte mixture at temperatures below about 60 to about 80° C. In some cases, some vaporization of electrolyte components may be permitted if the cell container is able to withstand the high pressure from gases inside the cell. In some implementations, the compounds of the diluent composition preferably do not solidify or precipitate from the electrolyte mixture at temperatures above about −30 to about −10° C. In some implementations, the diluent composition may include at least partially fluorinated (F-comprising) solvent(s). In some implementations, the diluent solvent(s) may comprise both H and F atoms in their composition. In some implementations, the diluent solvent(s) may comprise H, F and O atoms in their composition. In some implementations, the diluent solvent(s) may comprise C, H, O and F atoms in their composition. In some implementations, the diluent solvent(s) may comprise, on average, from 2 to 8 carbon (C) atoms per molecule (in some implementations, from 3 to 7 C atoms per molecule). In some implementations, the diluent solvent(s) may comprise (at least partially) fluorinated ether(s). In some implementations, the diluent composition includes 1,1,2,2-tetrafluoroethyl-2,2,3,3-tetrafluropropyl ether (TTE), a fluorinated ether (formula C₅H₄F₈O) shown as 208 in FIG. 2. In some implementations, TTE may constitute at least about 90 wt. % (e.g., about 90-about 95 wt. %, about 95-about 99 wt. %, or about 99-about 100 wt. %) of the diluent composition. In some implementations in which TTE is employed in the diluent composition, the mole fraction (concentration) of the TTE in the electrolyte may be in a range of about 15 mol. % to about 40 mol. % (e.g., in a range of about 15 mol. % to about 25 mol. %, or in a range of about 25 mol. % to about 40 mol. %). In some implementations in which TTE is employed in the diluent composition, the mole fraction (concentration) of the TTE in the electrolyte may be in a range of about 40 mol. % to about 55 mol. %. In some implementations in which TTE is employed in the diluent composition, a molar ratio of co-solvent composition to the TTE is in a range of about 1 to about 5 (e.g., about 1 to about 2, about 2 to about 3, about 3 to about 4, or about 4 to about 5). In some implementations, the diluent composition may include (in some designs, additionally) one or more of at least partially fluorinated ethers comprising 2 to 8 carbon atoms per formula, such as the following fluorinated ethers, in illustrative examples: bis(fluoromethyl) ether (formula C₂H₄F₂O), bis(difluoromethyl) ether (formula C₂H₂F₄O), pentafluoromethyl ether (C₂H₁F₅O), 1,2,2,2-tetrafluoroethyl trifluoromethyl ether (C₃HF₇O), pentafluoroethyl methyl ether (C₃H₃F₅O), bis(2,2,2-trifluorocthyl) ether (BTFE, C₄H₄F₆O), 1,1,2,2-tetrafluoroethyl-2,2,2,3-tetrafluoropropyl ether (TTE, C₅H₄F₈O), tris(2,2-difluorothyl) orthoformate (TDFEO), and bis(2,2-difluoroethyl)ether, tris(2,2,2-trifluoroethyl) orthoformate (TFEO, C₇H₇F₉O₃), to name a few. In some implementations, the ratio of H to F atoms in the diluent solvent composition may range from about 5:1 to about 1:5 (in some designs, from about 5:1 to about 2:1; in other designs, from about 2:1 to about 1:1; in other designs, from about 1:1 to about 1:2; in other designs, from about 1:2 to about 1:3; in other designs, from about 1:3 to about 1:5). In some implementations, the diluent composition may additionally include one or more fluorinated ethers other than the fluorinated ethers listed above.

In one or more embodiments of the present disclosure, if the electrolyte of the lithium-ion battery has a low ionic conductivity (<3 mS/cm) and the areal capacity loading is high (e.g., >about 4 mAh/cm²), the battery may suffer from low rate capability and high cell resistance, resulting in one or more of the following battery characteristics: low discharge voltage, low cycle life, low calendar life, high HT gassing, and inferior low temperature performance. In some designs, if a cell has low rate capability, it may induce a high voltage on the cathode, causing unwanted oxidation reactions such as those that cause non-Li metals to be removed from the cathode active material, unwanted gases to be evolved, and/or current collector corrosion. In some designs, if a cell has low rate capability, the anode and/or cathode may degrade more rapidly due to some particles undergoing more volume change than others. In some designs, if a cell has low rate capability, the cell may degrade through the plating of Li metal at the anode.

In one or more embodiments of the present disclosure, a lithium-ion battery may include an anode current collector, a cathode current collector, an anode disposed on and/or in the anode current collector, a cathode disposed on and/or in the cathode current collector, and any one of the electrolytes as described herein ionically coupling the anode and the cathode. For example, there may be a separator interposed in a space between the anode and the cathode, with the electrolyte impregnating the separator. In some implementations, the anode may comprise (A) silicon-carbon composite particles comprising carbon and silicon (e.g., (1) with the silicon part being arranged as active material particles and the carbon forming an inactive or substantially inactive part of scaffolding matrix with pores (sometimes referred to as porous carbon) on which the silicon active material is disposed and/or in which the silicon active material is disposed, and/or (2) with the silicon part being arranged as active materials particles in the composite particles and a carbon coating or a carbon shell being arranged around the composite particles) and/or (B) graphitic carbon particles comprising carbon (e.g., with carbon-comprising graphite as an active material) and being substantially free of silicon. In the case of (A) above, at least some of the silicon may be present in the composite particles as nanosized silicon and/or nanostructured silicon. In some implementations, the anode may contain a mixture (or blend) of (A) silicon-carbon composite particles and (B) graphitic carbon particles. In such cases, the anode is sometimes referred to as a blended anode herein. In some implementations, a mass of the silicon is in a range of about 10 wt. % to about 90 wt. % of a total mass of the anode. In some implementations, the anode may additionally include carbon nanotubes (e.g., single-wall carbon nanotubes) at a concentration of less than about 1 wt. % of the anode (not counting the weight of the current collector). In some implementations, the anode may additionally include carbon black at a concentration from about 1 wt. % to about 5 wt. % of the anode (not counting the weight of the current collector).

In some implementations, the diluent composition may be inert to reduction at the anode, oxidation at the cathode, and chemical decomposition through interaction with a salt or other organic and inorganic components. TTE is one such example of such a compound. In other implementations, the diluent may promote self-passivating reactions, forming stable SEI at the anode and CEI at the cathode to prevent undesirable reactions, which may be advantageous to reduce or prevent reactions at HT storage that cause an increase in cell impedance and/or gas generation; to extend the cell's calendar life and cycle life; and/or to improve the high rate cycle life of the cell.

FIG. 3 shows a Table 1 (302) which shows electrolyte compositions and associated selected battery performance characteristics for electrolytes ELY #1, #2, and #3. Hereinbelow, particular electrolyte formulations may be denoted as ELY followed by a number (e.g., ELY #1, ELY #2, etc.). Each of these electrolytes ELY #1, ELY #2, and ELY #3 comprise LiFSI (as the sole component in the lithium salt composition), FEC, EC, and TTE (as the sole component in the diluent composition). In addition to FEC and EC, the co-solvent compositions of electrolytes ELY #1, ELY #2, and ELY #3 comprise DMC, EP, and EP, respectively.

In one illustrative example, a test Li-ion battery cell with capacity of about 0.025 Ah may comprise: (i) an anode with Si—C nanocomposite active material particles (with specific capacity of about 1500 mAh/g when normalized to the mass of the anode without the current collector foil) casted on Cu current collector foil from a water-based suspension comprising a polyacrylic acid based binder and a carbon black conductive additive, (ii) a cathode with high-Ni NCM (LiNiₓCo_{y}Mn_{z}O₂ where x=0.8, y=0.1, and z=0.1) active material particles (with specific reversible capacity of about 190 mAh/g when normalized by the weight of the cathode without the current collector foil) casted on Al current collector foil from an organic solvent suspension comprising a polyvinylidene fluoride (PVDF)-based binder and a carbon black conductive additive, anode:cathode areal capacity ratio of about 1.15:1 and cycle start areal capacity loading of about 4.2 mAh/cm², charge voltage of about 4.3V, (iii) a polyethylene separator, and (iv) an ELY #1 comprising: about 16.7 mol. % LiFSI, about 1.7 mol. % FEC, about 1.7 mol. % EC, about 46.7 mol. % DMC, and about 33.3 mol. % TTE. Hereinbelow, particular electrolyte formulations may be denoted as ELY followed by a number (e.g., ELY #1, ELY #2, etc.).

In one illustrative example, a test Li-ion battery cell with capacity of about 0.025 Ah may comprise: (i) an anode with Si—C nanocomposite active material particles (with specific capacity of about 1500 mAh/g when normalized to the mass of the anode without the current collector foil) casted on Cu current collector foil from a water-based suspension comprising a polyacrylic acid based binder and a carbon black conductive additive, (ii) a cathode with high-Ni NCM (LiNiₓCo_{y}Mn_{z}O₂ where x=0.8, y=0.1, and z=0.1) active material particles (with specific reversible capacity of about 190 mAh/g when normalized by the weight of the cathode without the current collector foil) casted on Al current collector foil from an organic solvent suspension comprising a polyvinylidene fluoride (PVDF)-based binder and a carbon black conductive additive, anode:cathode areal capacity ratio of about 1.15:1 and cycle start areal capacity loading of about 4.2 mAh/cm², charge voltage of about 4.3V, (iii) a polyethylene separator, and (iv) an ELY #2 comprising: about 20 mol. % LiFSI, about 2 mol. % FEC, about 2 mol. % EC, about 56 mol. % EP, and about 20 mol. % TTE.

In one illustrative example, a test Li-ion battery cell with capacity of about 0.025 Ah may comprise: (i) an anode with Si—C nanocomposite active material particles (with specific capacity of about 1500 mAh/g when normalized to the mass of the anode without the current collector foil) casted on Cu current collector foil from a water-based suspension comprising a polyacrylic acid based binder and a carbon black conductive additive, (ii) a cathode with high-Ni NCM (LiNiₓCo_{y}Mn_{z}O₂ where x=0.8, y=0.1, and z=0.1) active material particles (with specific reversible capacity of about 190 mAh/g when normalized by the weight of the cathode without the current collector foil) casted on Al current collector foil from an organic solvent suspension comprising a polyvinylidene fluoride (PVDF)-based binder and a carbon black conductive additive, anode:cathode areal capacity ratio of about 1.15:1 and cycle start areal capacity loading of about 4.2 mAh/cm², charge voltage of about 4.3V, (iii) a polyethylene separator, and (iv) an ELY #3 comprising: about 16.7 mol. % LiFSI, about 1.7 mol. % FEC, about 1.7 mol. % EC, about 46.7 mol. % EP, and about 33.3 mol. % TTE.

FIG. 3 shows the compositions of three electrolyte formulations ELY #1, ELY #2, and ELY #3, and includes test reports of (1) the number of cycles to 80% energy retention (as reported in graphical plot 404 of FIG. 4) and (2) normalized discharge capacity, obtained by dividing discharge energy at 2 C-rate discharge, divided by discharge energy at 0.2 C-rate discharge (as reported in graphical plot 702 of FIG. 7). Li-ion battery cells were tested as described in detail hereinbelow with respect to FIG. 4 and FIG. 7.

Li-ion battery test cells respectively comprising ELY #1, ELY #2, and ELY #3 were tested in a cycle life test (results reported in graphical plots 402 and 404 in FIG. 4). The test cells were fabricated, and an initial formation procedure was carried out on the test cells. Charge/discharge test conditions comprise constant current, constant potential (CCCP) at about 0.5 C charge to about 4.3V and taper to about 0.05 C followed by the about 0.5 C discharge to about 2.5 V at about 25° C. Graphical plot 402 reports the capacity as a function of cycle number. Graphical plot 404 reports the energy retention as a function of cycle number. Herein, energy retention refers to the normalized discharge energy of the cell, relative to the discharge energy at cycle start, measured at the about 0.5 C discharge rate. ELY #1 utilizes DMC in the co-solvent composition whereas ELY #2 and ELY #3 utilize EP in the co-solvent composition. The battery test cells with DMC-based electrolyte (ELY #1) exhibit remarkably better cycle life compared to battery test cells with EP-based electrolytes (ELY #2, ELY #3). In the case of battery test cells with the DMC-based electrolyte (ELY #1), a capacity ranging between about 3.3 and about 3.5 mAh/cm² was measured after undergoing about 1000 charge-discharge cycles at a rate of about 0.5 C. Reduced stability of cells with ELY #2 and #3 may be linked to accelerated consumption of the SEI builders in these systems. In some designs, such a faster consumption may be mitigated by using higher quantities of such SEI builders and/or by further improving SEI stability via using a high temperature formation (e.g., conducting at least a portion (e.g., about 20-100% of time) of the formation cycle(s) at temperature in the range of about 40-80° C.) and/or using other electrolyte additives.

Li-ion battery test cells respectively comprising ELY #1, ELY #2, ELY #3, and a reference electrolyte (which did not contain a diluent) were tested in a calendar life test (graphical plots 502 and 504 in FIG. 5). The reference electrolyte comprised about 9 mol. % LiPF₆, about 2 mol. % LiFSI, about 44 mol. % EP, about 7 mol. % DEC, about 14 mol. % FEC, about 23 mol. % non-fluorinated cyclic carbonates, and less than about 2 mol. % of additive compounds. The test cells were fabricated, and an initial formation procedure was carried out on the test cells. Charge/discharge test conditions comprise constant current, constant potential (CCCP) at about 0.5 C charge to about 4.3V and taper to about 0.05 C followed by the about 0.5 C discharge at about 25° C. Prior to each storage period, the cells were charged to about 100% State of Charge (SOC), and discharged by about 5% SOC to leave about 95% SOC discharge capacity at the start of storage. The cells were stored for predetermined time periods at about 45° C. before being brought back to about 25° C. for further cycling. Normalized residual capacity (graphical plot 504 of FIG. 5) is defined as the first discharge capacity after the storage period, normalized by the remaining discharge capacity in the cell before the storage period. Normalized recoverable capacity (graphical plot 502 of FIG. 5) is defined as the fourth cycle discharge capacity after storage, normalized by the cycle start discharge capacity. Compared to the test cells comprising the reference electrolyte, test cells comprising ELY #1, ELY #2, and ELY #3 all exhibited extremely high normalized residual and normalized recoverable capacity.

The conductivity of electrolytes ELY #2, ELY #4, ELY #5, and ELY #6 were measured at about 25° C., as shown in Table 2 (602) of FIG. 6. The compositions of the respective electrolytes are also shown in Table 2 (602). Comparing ELY #2 (comprising EP and a small amount of cyclic carbonates EC and FEC) and ELY #4 (comprising DMC), ELY #4 has slightly lower conductivity. Comparing ELY #4 (sole component in the co-solvent composition is DMC) and ELY #5 (smaller amount of DMC than in ELY #4, and additionally including cyclic carbonate co-solvents PC, EC and FEC), ELY #5 has lower conductivity. Comparing ELY #4 (20% TTE) and ELY #6 (33.3% TTE, hence more TTE than in ELY #4), ELY #6 has lower conductivity.

Li-ion battery test cells respectively comprising ELY #1, ELY #2, and ELY #3 were tested in a discharge rate test (FIG. 7). The test cells were fabricated, and an initial formation procedure was carried out on the test cells. Charge/discharge test conditions comprise constant current, constant potential (CCCP) at about 0.5 C charge to about 4.3V and taper to about 0.05 C at about 25° C., followed by discharging at the predetermined discharge rates (in this case, about 0.2 C, about 0.5 C, about 1 C, about 2 C, and about 3 C) at about 25° C. The measured discharge capacities (discharge energies) were normalized to the discharge capacities (discharge energies) at the about 0.2 C discharge rate. Graphical plot 702 of FIG. 7 shows the normalized discharge capacity as a function of the discharge C-rate. Test cells comprising ELY #1 (DMC-based) exhibit a rapidly declining capacity at rates higher than about 1 C, whereas test cells comprising ELY #2 and ELY #3 (EP-based), have better rate capabilities. Note the difference in conductivity in Table 2 (602) is small. Therefore, this data points to differences in diffusivity, charge transfer resistance, and/or transference number. Test cells comprising ELY #2 (about 20% TTE, lower TTE mole fraction than in the about 33.3% in ELY #1 and ELY #3) have the best rate capability.

A Li-ion battery test cell comprising ELY #1 was tested in a high temperature storage test (FIG. 8). The test cells were fabricated, and an initial formation procedure was carried out on the test cells. The test cell was charged at constant current followed by constant potential (CCCP) at about 0.5 C charge to about 4.2V and taper to about 0.05 C at about 25° C., and the volume of the cell was measured. The cell was then stored at about 60° C. for about 72 hours, and then cooled back to room temperature. After about 1 hour at room temperature, the volume was measured again to calculate the volume increase and the gas in the cell was measured via gas chromatography (GC) coupled with pulsed-discharge helium ionization detector (PDHID) and Mass Spectroscopy (MS) detector. No fluorinated compounds with composition greater than about 1 vol. % were found, implying that TTE is unlikely to be a significant reactant generating gas at high temperature.

The above-described exemplary nanocomposite particles (e.g., anode or cathode particles) may generally be of any shape (e.g., near-spherical or a spheroidal or an ellipsoid (e.g., including oblate spheroid), cylindrical, plate-like, have a random shape, etc.) and of any size. The maximum size of the particle may depend on the rate performance requirements, on the rate of the ion diffusion into the partially filled particles, and/or on other parameters. For most applications, the average diffusion distance from the solid-electrolyte interphase (e.g., from the surface of the composite particles) to the inner core of the composite particles may be smaller than about 10 microns for the optimal performance.

Some aspects of this disclosure may also be applicable to conventional intercalation-type electrodes (e.g. cathodes with less nickel, anodes with less silicon) and may provide benefits of improved rate performance or improved stability, particularly for electrodes with medium and high-capacity loadings (e.g., greater than about 3-4 mAh/cm²).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A lithium-ion battery, comprising: an anode current collector; a cathode current collector; an anode disposed on or in the anode current collector; a cathode disposed on or in the cathode current collector; and an electrolyte ionically coupling the anode and the cathode, the electrolyte comprising (1) a lithium salt composition, (2) a co-solvent composition, and (3) a diluent composition, wherein: the lithium salt composition comprises lithium bis(fluorosulfonyl) imide (LiFSI); the co-solvent composition comprises dimethyl carbonate (DMC) and/or ethyl propionate (EP); the diluent composition comprises 1,1,2,2-tetrafluoroethyl-2,2,3,3-tetrafluropropyl ether (TTE); and the anode comprises composite particles comprising carbon and silicon, the composite particles comprising pores, and at least some of the silicon being nanosized silicon in the pores.

Clause 2. The lithium-ion battery of clause 1, wherein: a mole fraction of the LiFSI in the electrolyte is in a range of about 15 mol. % to about 22 mol. %.

Clause 3. The lithium-ion battery of any of clauses 1 to 2, wherein: a molar ratio of the co-solvent composition to the TTE is in a range of about 1 to about 5.

Clause 4. The lithium-ion battery of any of clauses 1 to 3, wherein: a mole fraction of the TTE in the electrolyte is in a range of about 15 mol. % to about 40 mol. %.

Clause 5. The lithium-ion battery of any of clauses 1 to 4, wherein: a molar ratio of the co-solvent composition to the LiFSI is in a range of about 2 to about 4.

Clause 6. The lithium-ion battery of any of clauses 1 to 5, wherein: a mole fraction of the co-solvent composition in the electrolyte is in a range of about 35 mol. % to about 65 mol. %.

Clause 7. The lithium-ion battery of any of clauses 1 to 6, wherein: the co-solvent composition additionally comprises one or more cyclic carbonates.

Clause 8. The lithium-ion battery of clause 7, wherein: the one or more cyclic carbonates are selected from vinylene carbonate (VC), fluoroethylene carbonate (FEC), ethylene carbonate (EC), and propylene carbonate (PC).

Clause 9. The lithium-ion battery of any of clauses 1 to 8, wherein: the co-solvent composition additionally comprises one or more esters of no more than five carbons.

Clause 10. The lithium-ion battery of clause 9, wherein: the one or more esters are selected from ethyl acetate, methyl butyrate, methyl propionate, and methyl acetate.

Clause 11. The lithium-ion battery of any of clauses 1 to 10, wherein: the co-solvent composition additionally comprises ethyl methyl carbonate (EMC) and/or diethyl carbonate (DEC).

Clause 12. The lithium-ion battery of any of clauses 1 to 11, wherein: the electrolyte exhibits an ionic conductivity of greater than about 3 mS/cm at an operating temperature of the lithium-ion battery.

Clause 13. The lithium-ion battery of any of clauses 1 to 12, wherein: a mass of the silicon is in a range of about 10 wt. % to about 90 wt. % of the anode.

Clause 14. The lithium-ion battery of any of clauses 1 to 13, wherein: the cathode comprises lithium nickel cobalt manganese oxide (NCM).

Clause 15. The lithium-ion battery of clause 14, wherein: the NCM is characterized by a composition LiNiₓCo_{y}Mn_{z}O₂, x+y+z=1, and x≥about 0.8.

Clause 16. The lithium-ion battery of any of clauses 1 to 15, wherein: a capacity of the lithium-ion battery is at least about 3.3 mAh/cm² after undergoing about 1000 or more charge-discharge cycles at a rate of at least about 0.5 C.

Clause 17. The lithium-ion battery of any of clauses 1 to 16, wherein: the anode additionally comprises graphite particles.

Clause 18. The lithium-ion battery of any of clauses 1 to 17, wherein: the anode additionally comprises carbon nanotubes.

Clause 19. The lithium-ion battery of any of clauses 1 to 18, wherein: the anode additionally comprises carbon black conductive additive.

Clause 20. The lithium-ion battery of any of clauses 1 to 19, wherein: the anode additionally comprises artificial graphite flakes as conductive additive.

Clause 21. The lithium-ion battery of any of clauses 1 to 20, wherein: the anode current collector comprises copper.

Clause 22. The lithium-ion battery of any of clauses 1 to 21, wherein: the cathode current collector comprises aluminum.

Implementation examples are described in the following numbered Additional Clauses:

Additional Clause 1. A lithium-ion battery, comprising: an anode current collector; a cathode current collector; an anode disposed on and/or in the anode current collector; a cathode disposed on and/or in the cathode current collector; and an electrolyte ionically coupling the anode and the cathode, the electrolyte comprising (1) a lithium salt composition, (2) a co-solvent composition, and (3) a diluent composition, wherein: the lithium salt composition comprises lithium bis(fluorosulfonyl) imide (LiFSI); the co-solvent composition comprises dimethyl carbonate (DMC) and/or ethyl propionate (EP); the diluent composition comprises 1,1,2,2-tetrafluoroethyl-2,2,3,3-tetrafluropropyl ether (TTE); and the anode comprises composite particles comprising carbon and silicon, the composite particles comprising pores, and at least some of the silicon being nanosized silicon in the pores.

Additional Clause 2. The lithium-ion battery of Additional Clause 1, wherein: a mole fraction of the LiFSI in the electrolyte is in a range of about 15 mol. % to about 22 mol. %.

Additional Clause 3. The lithium-ion battery of any of Additional Clauses 1 to 2, wherein: a molar ratio of the co-solvent composition to the TTE is in a range of about 1 to about 5.

Additional Clause 4. The lithium-ion battery of any of Additional Clauses 1 to 3, wherein: a mole fraction of the TTE in the electrolyte is in a range of about 15 mol. % to about 40 mol. %.

Additional Clause 5. The lithium-ion battery of any of Additional Clauses 1 to 4, wherein: a molar ratio of the co-solvent composition to the LiFSI is in a range of about 2 to about 4.

Additional Clause 6. The lithium-ion battery of any of Additional Clauses 1 to 5, wherein: a mole fraction of the co-solvent composition in the electrolyte is in a range of about 35 mol. % to about 65 mol. %.

Additional Clause 7. The lithium-ion battery of any of Additional Clauses 1 to 6, wherein: the co-solvent composition additionally comprises one or more cyclic carbonates.

Additional Clause 8. The lithium-ion battery of Additional Clause 7, wherein: the one or more cyclic carbonates are selected from vinylene carbonate (VC), fluoroethylene carbonate (FEC), ethylene carbonate (EC), and propylene carbonate (PC).

Additional Clause 9. The lithium-ion battery of any of Additional Clauses 1 to 8, wherein: the co-solvent composition additionally comprises one or more esters of no more than five carbons.

Additional Clause 10. The lithium-ion battery of Additional Clause 9, wherein: the one or more esters are selected from ethyl acetate, methyl butyrate, methyl propionate, and methyl acetate.

Additional Clause 11. The lithium-ion battery of any of Additional Clauses 1 to 10, wherein: the co-solvent composition additionally comprises ethyl methyl carbonate (EMC) and/or diethyl carbonate (DEC).

Additional Clause 12. The lithium-ion battery of any of Additional Clauses 1 to 11, wherein: the electrolyte exhibits an ionic conductivity of greater than about 3 mS/cm at an operating temperature of the lithium-ion battery.

Additional Clause 13. The lithium-ion battery of any of Additional Clauses 1 to 12, wherein: a mass of the silicon is in a range of about 10 wt. % to about 90 wt. % of the anode.

Additional Clause 14. The lithium-ion battery of any of Additional Clauses 1 to 13, wherein: the cathode comprises lithium nickel cobalt manganese oxide (NCM).

Additional Clause 15. The lithium-ion battery of Additional Clause 14, wherein: the NCM is characterized by a composition LiNiₓCo_{y}Mn_{z}O₂, x+y+z=1, and x≥about 0.8.

Additional Clause 16. The lithium-ion battery of any of Additional Clauses 1 to 15, wherein: a capacity of the lithium-ion battery is at least about 3.3 mAh/cm² after undergoing about 1000 or more charge-discharge cycles at a rate of at least about 0.5 C.

Additional Clause 17. The lithium-ion battery of any of Additional Clauses 1 to 16, wherein: the anode additionally comprises graphite particles.

Additional Clause 18. The lithium-ion battery of any of Additional Clauses 1 to 17, wherein: the anode additionally comprises carbon nanotubes.

Additional Clause 19. The lithium-ion battery of any of Additional Clauses 1 to 18, wherein: the anode additionally comprises a carbon black as a conductive additive.

Additional Clause 20. The lithium-ion battery of any of Additional Clauses 1 to 19, wherein: the anode additionally comprises artificial graphite flakes as a conductive additive.

Additional Clause 21. The lithium-ion battery of any of Additional Clauses 1 to 20, wherein: the anode current collector comprises copper.

Additional Clause 22. The lithium-ion battery of any of Additional Clauses 1 to 21, wherein: the cathode current collector comprises aluminum.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A lithium-ion battery, comprising:
an anode current collector;
a cathode current collector;
an anode disposed on and/or in the anode current collector;
a cathode disposed on and/or in the cathode current collector; and
an electrolyte ionically coupling the anode and the cathode, the electrolyte comprising (1) a lithium salt composition, (2) a co-solvent composition, and (3) a diluent composition,
wherein:
the lithium salt composition comprises lithium bis(fluorosulfonyl) imide (LiFSI);
the co-solvent composition comprises dimethyl carbonate (DMC) and/or ethyl propionate (EP);
the diluent composition comprises 1,1,2,2-tetrafluoroethyl-2,2,3,3-tetrafluropropyl ether (TTE); and
the anode comprises composite particles comprising carbon and silicon, the composite particles comprising pores, and at least some of the silicon being nanosized silicon in the pores.

2. The lithium-ion battery of claim 1, wherein:
a mole fraction of the LiFSI in the electrolyte is in a range of about 15 mol. % to about 22 mol. %.

3. The lithium-ion battery of claim 1, wherein:
a molar ratio of the co-solvent composition to the TTE is in a range of about 1 to about 5.

4. The lithium-ion battery of claim 1, wherein:
a mole fraction of the TTE in the electrolyte is in a range of about 15 mol. % to about 40 mol. %.

5. The lithium-ion battery of claim 1, wherein:
a molar ratio of the co-solvent composition to the LiFSI is in a range of about 2 to about 4.

6. The lithium-ion battery of claim 1, wherein:
a mole fraction of the co-solvent composition in the electrolyte is in a range of about 35 mol. % to about 65 mol. %.

7. The lithium-ion battery of claim 1, wherein:
the co-solvent composition additionally comprises one or more cyclic carbonates.

8. The lithium-ion battery of claim 7, wherein:
the one or more cyclic carbonates are selected from vinylene carbonate (VC), fluoroethylene carbonate (FEC), ethylene carbonate (EC), and propylene carbonate (PC).

9. The lithium-ion battery of claim 1, wherein:
the co-solvent composition additionally comprises one or more esters of no more than five carbons.

10. The lithium-ion battery of claim 9, wherein:
the one or more esters are selected from ethyl acetate, methyl butyrate, methyl propionate, and methyl acetate.

11. The lithium-ion battery of claim 1, wherein:
the co-solvent composition additionally comprises ethyl methyl carbonate (EMC) and/or diethyl carbonate (DEC).

12. The lithium-ion battery of claim 1, wherein:
the electrolyte exhibits an ionic conductivity of greater than about 3 mS/cm at an operating temperature of the lithium-ion battery.

13. The lithium-ion battery of claim 1, wherein:
a mass of the silicon is in a range of about 10 wt. % to about 90 wt. % of the anode.

14. The lithium-ion battery of claim 1, wherein:
the cathode comprises lithium nickel cobalt manganese oxide (NCM).

15. The lithium-ion battery of claim 14, wherein:
the NCM is characterized by a composition LiNiₓCo_{y}Mn_{z}O₂, x+y+z=1, and x≥about 0.8.

16. The lithium-ion battery of claim 1, wherein:
a capacity of the lithium-ion battery is at least about 3.3 mAh/cm² after undergoing about 1000 or more charge-discharge cycles at a rate of at least about 0.5 C.

17. The lithium-ion battery of claim 1, wherein:
the anode additionally comprises graphite particles.

18. The lithium-ion battery of claim 1, wherein:
the anode additionally comprises carbon nanotubes.

19. The lithium-ion battery of claim 1, wherein:
the anode additionally comprises a carbon black as a conductive additive.

20. The lithium-ion battery of claim 1, wherein:
the anode additionally comprises artificial graphite flakes as a conductive additive.

21. The lithium-ion battery of claim 1, wherein:
the anode current collector comprises copper.

22. The lithium-ion battery of claim 1, wherein:
the cathode current collector comprises aluminum.
